(19) United States
(12) Patent Application Publication
(10) Pub. No.: US 2013/0317961 A1
(43) Pub. Date: Nov. 28, 2013

(54) METHODS AND SYSTEMS FOR ORDER MATCHING

(71) Applicants: Roberto Malatesta, Milano (IT); Antonio Castagna, Milano (IT); Davide Boiardi, London (GB)

(72) Inventors: Roberto Malatesta, Milano (IT); Antonio Castagna, Milano (IT); Davide Boiardi, London (GB)

(73) Assignee: BGC Partners, Inc., New York, NY (US)

(21) Appl. No.: 13/478,201

(22) Filed: May 23, 2012

(51) Int. Cl. G06Q 40/04

(52) U.S. Cl. 705/37

(57) ABSTRACT

Systems, methods, apparatuses and articles of manufacture are provided for receiving an order for a quantity of a non-standardized currency at a predicted exchange rate. The order is to be transacted on a fixing date that occurs within a restricted period of time. A selective aiming algorithm is applied to a set of orders. All possible combinations are computed. A selected combination that generates a greatest volume of transactions is selected. An indication that the selected combination has been selected is displayed on a display.

### FIELD OF THE INVENTION

The present invention relates generally to electronic trading systems. More particularly, aspects of some embodiments relate to foreign currency trading for non-standardized currencies.

### BACKGROUND

Many different types of financial instruments may be used in the trading of foreign currencies. Some examples of these financial instruments may include forward contracts, swaps, non-deliverable forwards (NDF), and futures. A trader may consider the type of foreign currency, the stability of the country, and other factors in determining which type of financial instrument to use. It also may be desirable to have electronic trading of these foreign currencies.

### BRIEF DESCRIPTION OF THE FIGURES

Further characteristics, features and advantages of the present invention will be apparent upon consideration of the following detailed description of the invention, take in conjunction with the following drawings, and in which:

FIG. 1 is a block diagram of a foreign exchange market.

FIG. 2a is a pictorial block diagram of a system in accordance with an aspect of the invention.

FIG. 2b is a pictorial block diagram of a system in accordance with an aspect of the invention.

FIG. 3a is a screenshot of an embodiment of the system's interface.

FIG. 3b is a screen shot of an embodiment of the system's interface.

FIG. 4 is a screen shot of an order entry window.

FIG. 5 is a block diagram of a matching process.

FIG. 6 is a screen shot of a matcher window.

FIG. 7 is a screen shot of a credit limit window.

FIG. 8 is a screen shot of a curve window.

FIG. 9 is a screen shot of a trade history window.

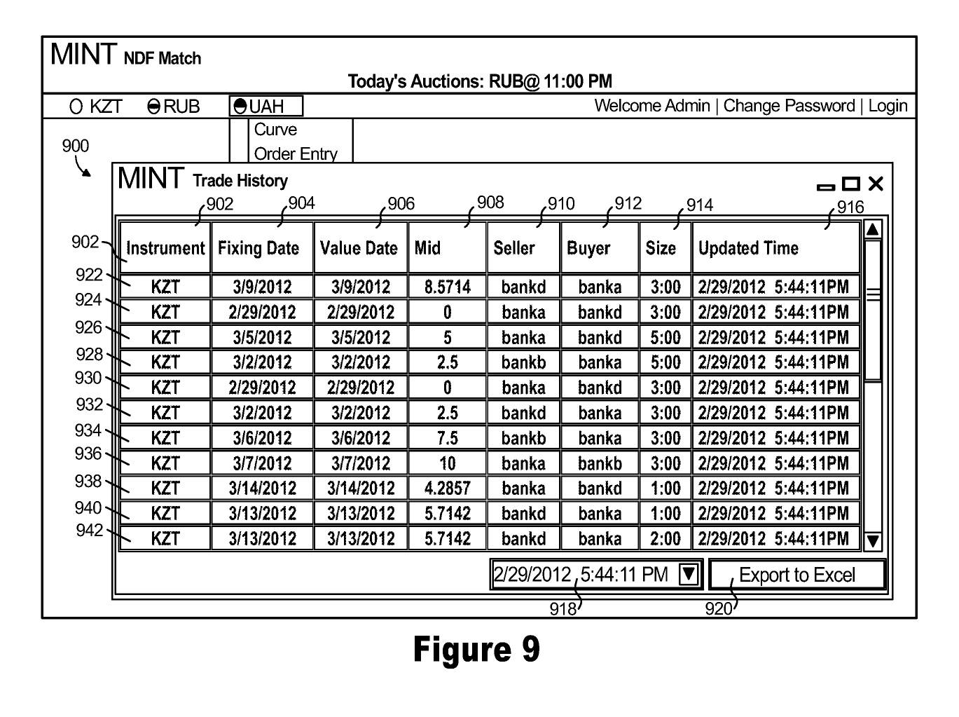

FIG. 10 is a screen shot of an auction window.

FIG. 11 is a flow diagram of the matching process.

FIG. 12 is a flow diagram of the matching process.

FIG. 13 is a flow diagram of the matching process.

### SUMMARY OF THE INVENTION

This document describes systems and techniques for electronic trading, such as foreign currencies and swaps.

In one implementation, a computer-implemented method for receiving an order for a quantity of a non-standardized currency at a predicted exchange rate. The order is to be transacted on a fixing date that occurs within a restricted period of time. The order is stored in a database with a plurality of orders that are unmatched. The order and the plurality of orders are received before an auction deadline has expired.

In certain aspects, the system computes that the auction deadline has expired. In response to the computing that the auction deadline has expired, a set of orders comprising all orders for the non-standardized currency that are unmatched is generated. A selective aiming algorithm is applied to the set of orders in order to generate a smaller set of orders.

In other aspects, the system computes all possible combinations of the orders. Each combination comprises at least one matching relationship between an order of the smaller set with another order of the smaller set. The system also computes a volume of transactions that is generated by each combination. Based on the volume of transactions, a selected combination that generates a greatest volume of transactions is selected. An indication that the selected combination has been selected is displayed on a display.

### DETAILED DESCRIPTION

The following sections I-XI provide a guide to interpreting the present application.

### I. Terms

The term “product” means any machine, manufacture and/or composition of matter, unless expressly specified otherwise.

The term “product” means a machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing.

An indication of a thing may include an electronic message that identifies the thing (e.g., an identification of a widget by a serial number affixed to the widget, an identification of a widget by one or more characteristics of the widget). An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates may things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget, but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget, but does not include anything else.

The term “compose” and variations thereof mean “to make up the constituent parts of, component of or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The term “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect—it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet) Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### III. Disclosed Examples and Terminology are not Limiting

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. §1.72(b).

The headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category. An enumerated list of items (which may or may not be numbered) does not imply that any or all of the items are equivalent to each other or readily substituted for each other. All embodiments are illustrative, and do not imply that the invention or any embodiments were made or performed, as the case may be.

### IV. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically-stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back in to plaintext. An example of an asymmetric key algorithm is the RSA algorithm.

### V. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VI. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### VII. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### VIII. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the claims herein.

### DETAILED DESCRIPTION OF EXEMPLARY EMBODIMENTS

Some embodiments may relate generally to a system for conducting electronic foreign currency transactions. Specifically, some embodiments may include methods, article of manufactures and apparatuses relating to a system that is capable of handling currency transactions, such as forward contracts and swaps of non-standardized currencies. However, the system is operable on many other types of financial instruments as well, including forward contracts, fixed income, equities, listed derivatives, swapations, and so on. The system also may trade non-currency commodities, such as interest deposits, etc. . . .

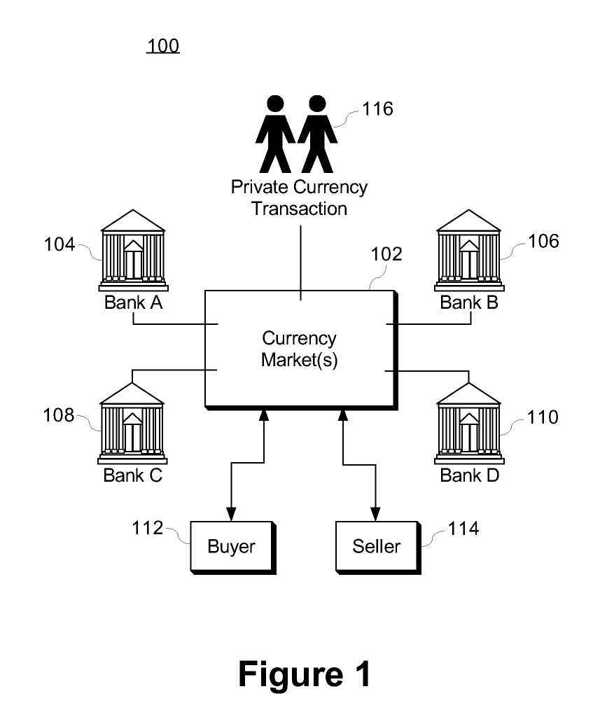

FIG. 1 illustrates an exemplary foreign currency system 100 that comprises currency market (or markets) 102 in which participants, such as Bank A 104, Bank B 106, Bank C 108 and Bank D 110 may exchange currencies. Buyer 112 may use currency market 102 to purchase a desired currency from participating seller 114. Currency system 100 also may be employed to provide information or guidance of currency prices for one or more currency transactions 116. In some embodiments, buyer 112 and seller 114 are traders who are purchasing and selling foreign currencies on behalf of a client participant. In other embodiments, trader 112 and seller 114 are transacting on behalf of themselves.

Although the participants in the example of FIG. 1 are banks, a participant may be any type of entity, such as a private investor, a commercial bank, an investment bank, a government, a corporation, a cash manager, a mutual fund, a hedge fund and/or a pension fund. These entities may conduct foreign transactions for a variety of reasons, including financing international trade, managing international investment portfolios and implementing monetary policies.

Typically, in foreign exchange (FX) transactions, currencies are priced in pairs: one currency is traded against another currency. Many of these trading decisions are based on the currency exchange rates. These foreign currency exchange rates often fluctuate due to various factors. Some of these factors may include a country's political stability, economic performance, public debt, fiscal policies, differentials in inflation, differentials in interest rates and terms of trade (such as export and import activities).

The FX market currently provides several mechanisms for investors seeking to speculate on or hedge against these fluctuations in currency prices. Some of these instruments may include forward contracts, swaps, future contracts, option contracts and spot transactions. Although the examples used within the present application relate to foreign currency transactions, the embodiments of the system are not limited to that application alone.

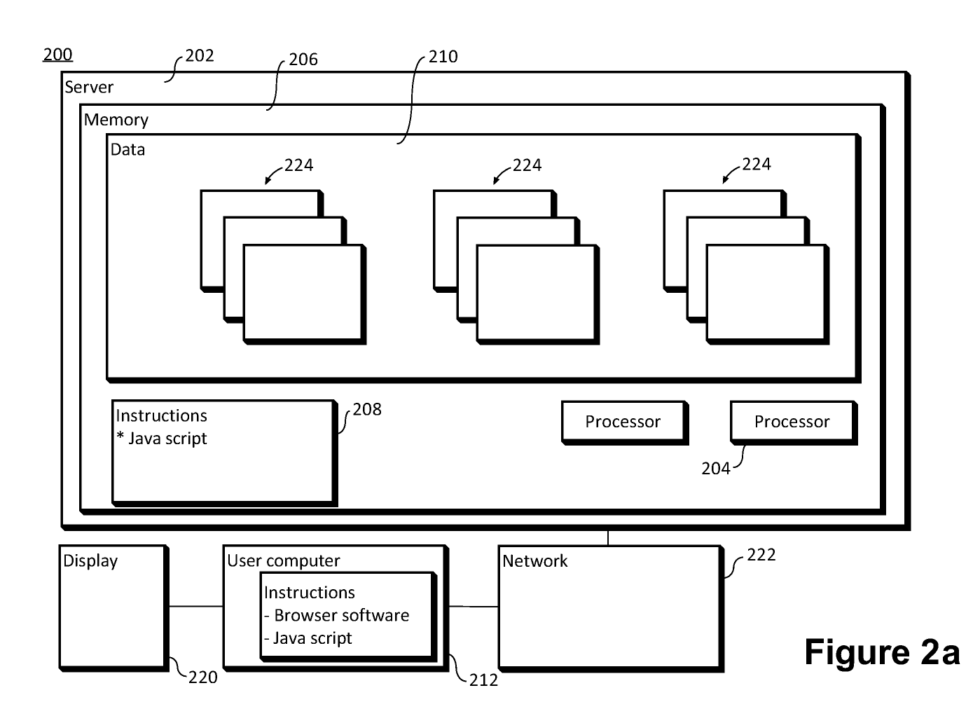

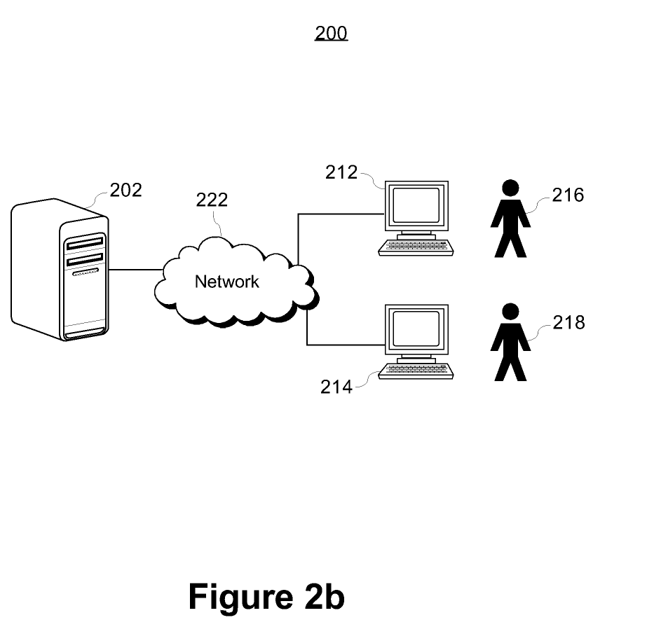

As shown in FIGS. 2a-2b, system 200 in accordance with some embodiments include server 202 containing a plurality of processors 204, memory 206 and other components typically present in general purpose computers.

Each trader's trading software application is integrated in a marketplace network for delivering a data stream to and from system 200 to the marketplace. In some embodiments, the data is delivered in real-time. In other embodiments, due to various delays in transmissions and/or latencies in the system, a lag time exists in the delivery of the data. System 200 receives buy/sell orders from the various traders and sends the orders to the marketplace's central processing server 202. System 200 is also capable of receiving data feed from central processing server 202.

Memory 206 stores information accessible by at least one processor 204, including instructions 208 that may be executed by processor 204 and data 210 that may be retrieved, manipulated or stored by processor 204. The memory may be of any type capable of storing information accessible by processor 204, such as a hard-drive, memory card, ROM, RAM, DVD, CD-ROM, write-capable, read-only memories and other computer media.

Processor 204 may be any number of well known processors, such as processors from Intel Corporation. Alternatively, processor 204 may be a dedicated controller such as an ASIC.

Instructions 208 may be any set of instructions to be executed directly (such as machine code) or indirectly (such as scripts) by processor 204. In that regard, the terms “instructions,” “steps” and “programs” may be used interchangeably herein. The instructions also function as an algorithm allowing the processor to perform the purposes intended by the instructions. The instructions may be stored in object code form for direct processing by the processor, or in any other computer language including scripts or collections of independent source code modules that are interpreted on demand or compiled in advance. Functions, methods and routines of the instructions are explained in more detail below.

Data 210 may be retrieved, stored or modified by processor 204 in accordance with instructions 208. For instance, although the embodiments are not limited by any particular data structure, the data may be stored in computer registers, in a relational database as a table having a plurality of different fields and records, XML documents, or flat files. The data also may be formatted in any computer readable format such as, but not limited to, binary values, ASCII or Unicode. Moreover, the data may comprise any information sufficient to identify the relevant information, such as descriptive text, proprietary codes, pointers, references to data stored in other memories (including other network locations) or information which is used by a function to calculate the relevant data.

Although the processor and memory are functionally illustrated in FIG. 2 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

As shown in FIGS. 2a and 2b, the computer may be a server 202 communicating with one or more client computers 212-214. Each client computer may be configured similarly to server 202, with a processor, memory and instructions. Each client computer 212-214 may be a personal computer, intended for use by a person 216-218, having all the internal components normally found in a personal computer such as a central processing unit (CPU), display 220, CD-ROM, hard-drive, user input devices (for example, a mouse, keyboard, touch-screen or microphone), speakers, modem and/or network interface device (telephone, cable or otherwise) and all of the components used for connecting these elements to one another. Moreover, computers in accordance with the systems and methods described herein may comprise any device capable of processing instructions and transmitting data to and from humans and other computers, including general purpose computers, network computers lacking local storage capability, PDA's with modems, Internet-capable wireless phones, Google glasses and other augmented reality devices.

Server 202 and client computers 212-214 are capable of direct and indirect communication, such as over network 222. Although only a few computers are depicted in FIGS. 2a-2b, it should be appreciated that a typical system can include a large number of connected computers, with each different computer being at a different node of network 222. The network, and intervening nodes, may comprise various configurations and protocols including the Internet, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks and wireless interfaces. Server 202 may be a web server.

Although certain advantages are obtained when information is transmitted or received as noted above, other aspects of various embodiments are not limited to any particular manner of transmission of information. For example, in some aspects, the information may be sent via a medium such as a disk, tape or CD-ROM. In other aspects, the information may be transmitted in a non-electronic format and manually entered into the system. Yet further, although some functions are indicated as taking place on a server and others on a client, various aspects of various embodiments may be implemented by a single computer having a single processor.

Referring back to FIG. 2a, data 210 includes databases 224, which stores the buy/sell orders for various foreign currencies. The system and method is not limited to a particular type or format. Databases 224 may store information as a bitmap, vector file, or other data format. Databases 224 also may store information that pertains to one or more parameters associated with each buy/sell order. Some of these parameter data may include, but not limited to, the restricted time period of an order, the credit limit between participants parties, desired quantity of orders, trading curves, and the minimum trading amount that is required for initiating a match. In some embodiments, databases 224 are stored in cloud-based applications which are accessible by users through a web browser or a mobile app. In such instances, the software and data may be stored on servers at a remote location.

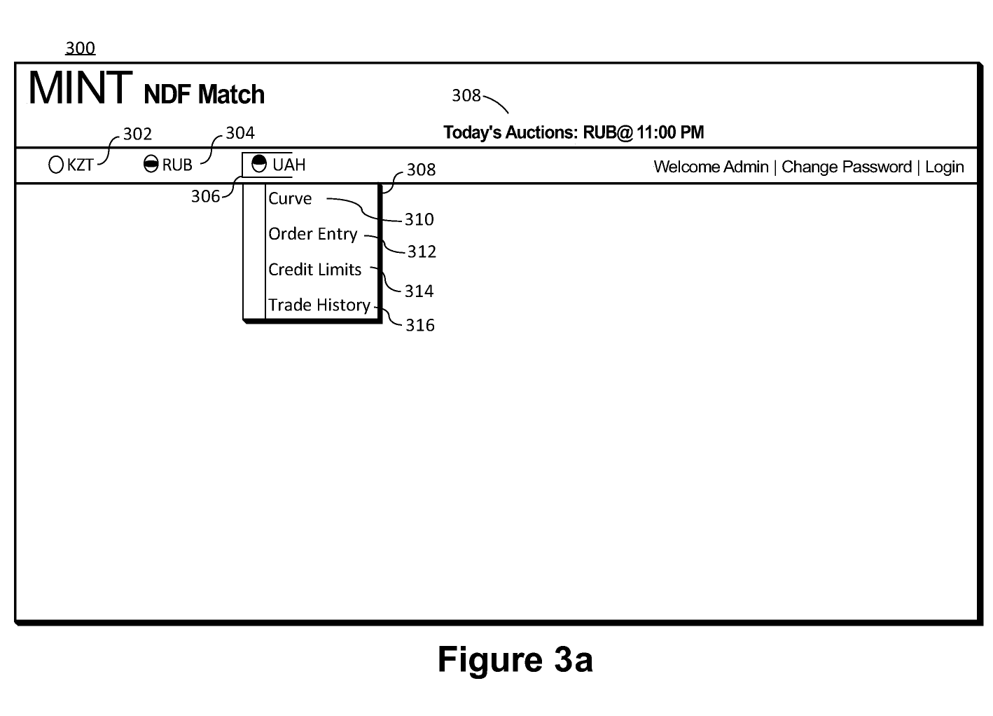

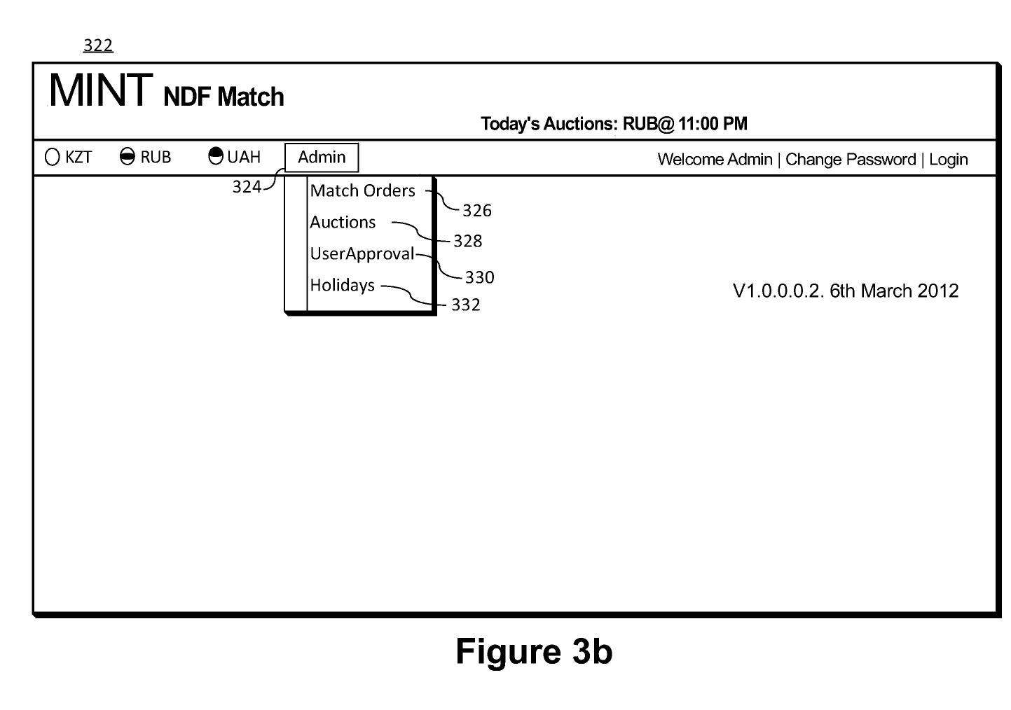

FIGS. 3a and 3b provide screen shots in accordance with an aspect of the system and method. Specifically, FIG. 3a depicts trader interface 300, as it may appear to a trader who logs onto system 200. FIG. 3b depicts broker interface 322, as it may appear to a broker who logs onto system 200. While trader interface 300 and broker interface 322 share many similar elements, they also offer different functionalities as well. In some embodiments, broker interface 322 provides administrative options that may not be available through trader interface 300. For example, a user logged into broker interface 322 may have the ability to change the trading curve, whereas a user logged onto trading interface 300 may not. Broker interface 322 also may offer admin tab 324, which when selected offers a plurality of broker specific sub-tabs. Some examples of these sub-tabs are illustrated in FIG. 3b. The sub-tabs may include: sub-tab 326 for matching received orders, sub-tab 328 for scheduling auction times; sub-tab 330 for user approvals, and sub-tab 332 for editing the scheduled holidays.

Both the trader and broker log into system 200 by using a unique username and password login credential. This login credential enables system 200 to recognize that buy/sell orders are coming from a particular trader.

As shown in FIG. 3a, the trader is presented with trading interface 300 after logging into trading system 200. The trader may select a type of foreign currency to trade via one of tabs 302-306. In the example of FIG. 3a, trader interface 300 offers a choice of the following currencies: KZT, RUB and UAH, where each currency corresponds to tabs 302, 304 and 306, respectively.

Although the example in FIG. 3a shows tabs for KZT, RUB and UAH, system 200 is not limited to these foreign currencies. System 200 is capable of handling any type of foreign currencies and/or type of financial instruments. For instance, the types of non-standardized foreign currencies that are transacted on system 200 may include: Argentine peso (ARS); Brazilian real (BRL), Chilean peso (CLP), Chinese renminbi (CNY), Colombian peso (COP), Guatemalan quetzal (GTQ), Indian rupee (INR), Indonesian rupiah (IDR), Malaysian ringgit (MYR), Israeli shekel (ILS), Peruvian nuevo sol (PEN), Philippine peso (PHP), South Korean won (KRW), Taiwan dollar (TWD), Venezuelan bolivar (VEB) and Vietnamese d [symbol] ng (VND). System 200 may be capable of handling any type of non-standardized and standardized currencies.

In one aspect of some embodiments, the trader selects a foreign currency through the use of a mouse. By moving a cursor over one of currency tabs 302-306, trader interface 300 generates a pull-down menu that further displays the relevant sub-tabs. Examples of these sub-tabs may include: sub-tab 310 for generating a graph of the trading curve, sub-tab 312 for generating an order entry window, sub-tab 314 for generating a credit limit window and sub-tab 316 for depicting the trading history of previous transactions.

Referring back to FIG. 3a, trading interface 300 also may display the auction time in display 318. The auction time indicates a deadline in which all submitted orders must be received by system 200. Instead of matching using a first-in, first-out process (FIFO), in some aspects of the embodiments, system 200 waits to match all of the submitted orders in a single cycle after the auction time has expired. By waiting to match the submitted orders on a single cycle, system 200 is able to select a combination of matching relationships that generates the greatest total volume of transactions.

Although the examples used in the present application describe a matching process that occurs in a single run cycle, there are some embodiments of system 200 that may utilize some or all of a first-in, first-out matching process as well. Furthermore, some embodiments of system 200 also have multiple auction times. In such instances, the trader may select a specific auction time from the multiple auction times shown in display 318.

In some aspects of the embodiments, a trader may have an opportunity to cancel and/or edit any previously submitting orders. For instance, in some embodiments, if the trader submits his request to cancel before expiration of the auction time in display 318, then system 200 removes the order. An indication may be sent to the trader notifying him of this cancellation.

Once the auction time in display 318 has expired, the broker may submit all the received orders to system 200 for processing. Using the matching process, system 200 seeks to match the submitted orders in a manner that optimizes the total volume of transactions. In one aspect of some embodiments, the submission of the buy/sell orders may occur periodically, such as once a day. However, in other aspects of some embodiments, the submission of the buy/sell orders may occur more frequently than once a day. For example, the buy/sell orders may be processed every half-hour, once an hour, several times a day, or any frequency that is greater than once a day. In another aspect of some embodiments, the submission of the orders may occur less frequently than once a day. For example, the buy/sell orders may be processed every other day, once a week, once a month, or any frequency that is less than once a day.

In some embodiments, the submission of the buy/sell orders occurs after a triggering threshold or event. Any number of factors and considerations may be used for the triggering event. For example, a triggering event may occur when the quantity of received orders exceeds a threshold number. In another example, the triggering event may occur when the aggregate volume of the received orders exceeds a threshold amount. In yet another embodiment, the triggering event may occur when the amount of a single order exceeds a threshold amount.

In one aspect of the embodiments, the triggering event may be determined by a broker before any buy/sell orders are submitted to system 200. In another aspect of the embodiment, the triggering event may be determined after one or more buy/sell orders have been received by system 200. The triggering event is not limited to being submitted by the broker alone. A client participant and/or any third-party entity also may indicate a triggering event to system 200.

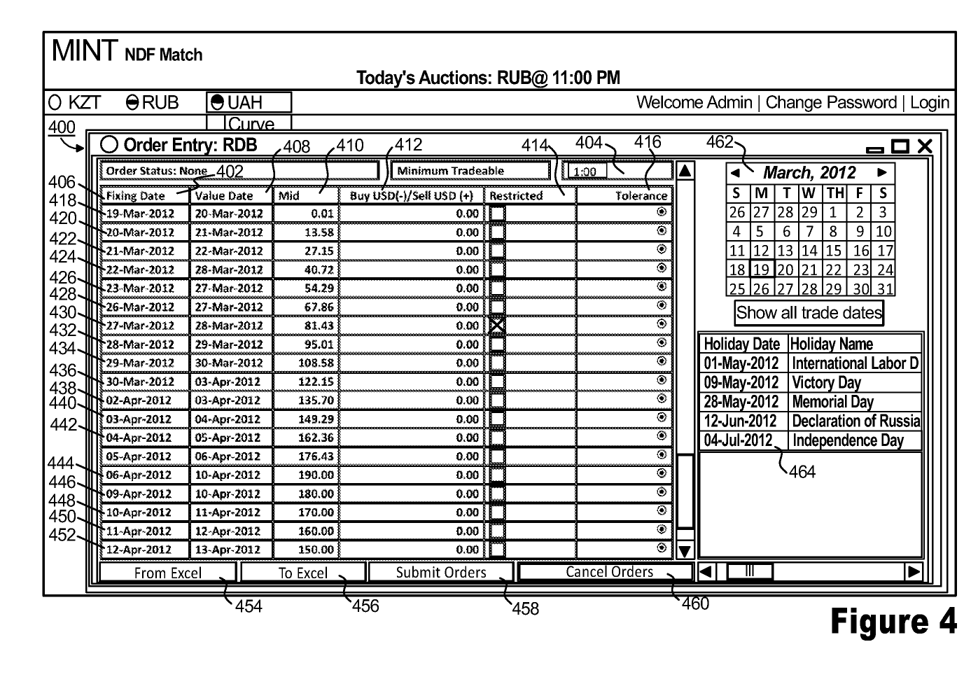

FIG. 4 provides a screen shot of one embodiment of order entry window 400, which is generated by system 200 in response to the selection of sub-tab 314 in trading interface 300. A trader enters his order requests using order entry window 400. Each of rows 406-452 corresponds to a specific fixing date. To place an order for a currency on a particular fixing date, the trader enters the desired quantity of the currency into the one of rows 406-452 in buy/sell column 412.

In one aspect of the embodiments, the trader indicates that an order is a buy order by entering a “+” sign in front of the desired quantity. He also indicates that an order is a sell order by entering a “−” sign in front of the desired quantity.

Column 402 shows the available fixing dates for a period of time. The fixing date represents the date on which the currency transaction occurs. The fixing date differs from the value date (as depicted in column 408) which represents the date on which the currency is actually delivered. The value date may occur on or after the fixing date. In on aspect of the embodiments, the value date occurs 1-2 business days after the fixing date. The exemplary example of the present application describes a situation where the amount of contracted currency is delivered on the value date. However, in some embodiments, only a difference of the nominal amount is delivered. A difference is calculated between the predicted exchange rate and the actual exchange rate on the fixing date. This calculated difference is applied to the base currency amount (or nominal amount) and the different is delivered on the value date.

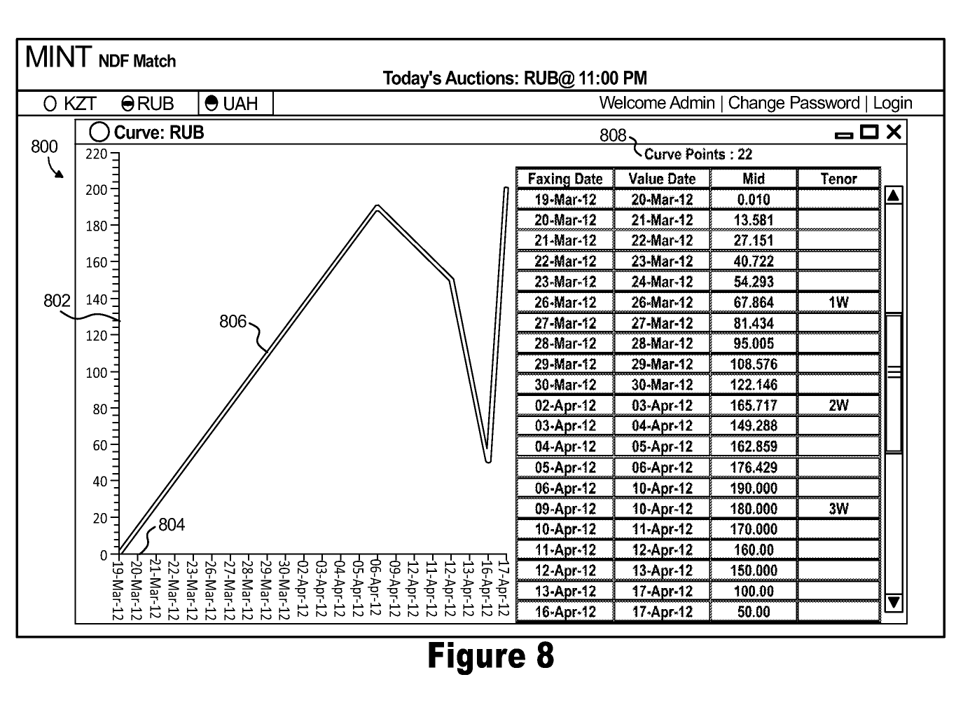

Column 410 shows the mid-point exchange rates (or mid-rates) for each of the fixing date. In some aspects of the embodiments, the mid-point rate is predicted by the broker in advance of the system receiving any orders. As shown in FIG. 8 (and describe in greater detail below), both traders and brokers may view the mid-rates via a trading curve, which is displayed in curve window 800. System 200 uses the mid-rates to calculate the price of the currency for a particular fixing date. In most embodiments, system 200 uses the mid-point rate, regardless of the actual currency exchange rates for a particular fixing date.

In some embodiments, system 200 requires that all matched orders satisfy a zero-sum requirement within a designated time period. The designated period of time is sometimes referred to as the restricted time period or reset time period. In order for an order to be matched by system 200, a counterorder, or switch order, in the opposite amount must be transacted within the restricted time period. For example, Client 1 submits a buy order in the amount of +4M. The order has a 30-day restricted period of time. Thus, in order for system 200 to match the buy order of +4M, Client 1 also must submit a sell order in the equal amount of −4M, in which the sell order must have a fixing date that occurs within the 30-day restricted period of time. The zero-sum requirement helps ensure that the trader does not bear too much risk. It helps mitigate a trader's exposure. In one aspect of the embodiments, the zero-sum requirement is used to hedge risk tails. Thus, the zero-sum requirement may serves as a protection against the sometimes irrational, unpredictable events that may take place in the market.

Although the examples described in the present application presume a zero-sum balance requirement, it is possible, in other embodiments to opt out of the zero-sum balance requirement and have the participant take on the additional risk. This additional risk, or exposure risk, may be defined in a number of different ways. In one embodiment, the exposure risk may be defined as a pre-defined amount. This pre-defined amount may be represented in terms of the base currency, the non-standardized currency or any other amount. The pre-defined amount may be determined by the participant, trader, broker, or any other entity. For example, a participant may define an exposure limit of $30M USD, which allows the participant to deviate from the zero-sum balance within plus or minus $30M USD.

In another embodiment, the exposure limit may be represented on a flexible or sliding scale. For example, the participant's exposure limit may be linked with the volume of transactions that is traded. In another example, the exposure limit may be a percentage of the total volume of transactions. Thus, if system 200 matches $500M USD in transactions, then the exposure limit would be $50M USD. In this example, the participant would be allowed to deviate from the zero-sum balance requirement within the exposure limit of $50M USD.

In yet another embodiment, a participant specifies the exposure limit in terms of a base currency. For each different type of currency that is traded, the amount of the exposure limit is calculated based on that base currency. As a result, on a given day, the exposure limit for each type of currency may vary depending on the exchange rate for the day. For example, assume the exposure limit for Participant A is set to $50M USD, then if Participant A is trading in Russian rubles, his exposure limit may be the ruble equivalent of $50M USD for that day. If Participant A, then switches to trade in Japanese yen, then his exposure limit translates into the yen equivalent of $50M USD for that day. In some embodiments, the exposure limit for different currencies may be pre-determined to be different amounts. For example, the exposure limit for the Japanese yen may be pre-defined as $50M, while the exposure limit for the Russian ruble may be pre-defined as $1M.

In one aspect of the embodiments, system 200 assigns a default restricted time period to each order that is submitted. This default period of time may be pre-determined by a broker before any transactions have occurred on system 200. A trader, client, third-party entity, or any other entity also may pre-determine the default period of time. In some embodiments, the default restricted time period may be shown by the total number of rows 406-452 that are displayed in order window 400.

In another aspect of the embodiments, the default restricted period of time may be further customized by a user of system 200. For instance, the default restricted time period may be divided into smaller intervals of time. This customization may be done by the trader, the broker, the client, some other third-party entity, etc. . . . In the example shown in FIG. 4, a trader may customize the default restricted time period by selecting one or more boxes in column 414. By selecting a box in column 414, the trader indicates to system 200 that he wishes to divide the default restricted time period in multiple shorter time periods. System 200 will attempt to satisfy the zero-sum requirement for the shortened restricted time period. For example, if the trader selects the restricted box for the fixing date of Mar. 27, 2012 (row 430), then system 200 will interpret a new 7-day restricted time period that runs from Mar. 19, 2012 to Mar. 27, 2012. System 200 will match only the orders that have fixing dates that fall within this period of time. Conversely, these orders will not be matched with orders having fixing dates that fall outside the new 7-day restricted time period.

As described above, system 200 uses the checked box (or boxes) to determine the beginning point and end point for the customized restricted time periods. If the trader does not check any boxes in column 414, then system 200 relies on the default period of time. As explained above, the restricted time period is considered by system 200 during the matching process. Thus, the matching process becomes increasingly complicated as more and more orders are received by system 200, especially where each submitted order may have one or more restricted time periods.

During the matching process, system 200 generates a smaller set of submitted orders by removing some orders through the selective aiming process (as detailed later). System 200 then evaluates all of the possible combinations between the submitted orders in this smaller set. From there, system 200 selects a combination of orders that generates the highest total volume of transactions.

At a minimum, a combination comprises at least four orders: an original order, a switch order that corresponds to the original order, a matching order that matches at least a portion of the original order, and a switch order that corresponds to the matching order. Assuming that the two switch orders are able to match each other, these four orders would compose a single combination. System 200 calculates the total volume of transaction for a combination by aggregating the amount of volume that is moved during each leg of a trade. For example, if system 200 matches an amount of +4M for a buy order with an amount of −4M for a sell order, then a volume of 4M is matched during that particular trade.

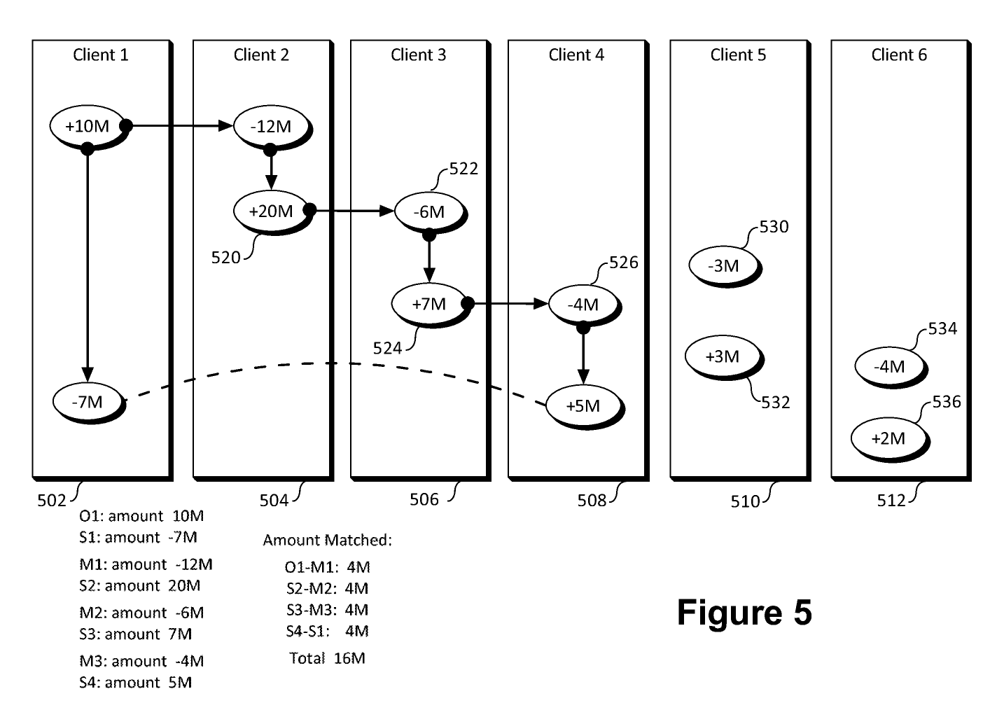

FIG. 5 illustrates a simplified example of the matching process. In this example, there are six clients who have submitted orders to system 200 by the auction deadline. These six clients are represented by boxes 502-512. All the orders submitted by a client are located within a single box. For example, order 514 and its corresponding switch order 516 are submitted by Client 1, and as a result, both order 514 and switch order 516 are located within box 502.

Based on the orders shown in FIG. 5, system 200 may determine at least two possible combinations. One possible combination would match order 514 with order 530, which results in a 3M volume match during that trade. Order 514 also corresponds to switch order 516 which is matched with switch order 532. As a result, an additional 3M volume is matched during that particular trade. Thus, the total volume matched for this particular combination is 6M.

System 200, however, may determine that a second combination results in an aggregate total volume that is greater than 6M. In fact, system 200 may determine that this second combination produces the greatest amount of total volume compared against all other calculated combinations. In response to such a determination, system 200 will disregard the first combination (and all other calculated combinations), and instead, system 200 will match the received orders according to this second combination.

In one aspect of some embodiments, system 200 attempts to maximize the aggregate total volume using the least number of exchanges. During the matching process, system 200 may determine an aggregate total volume for each of the calculated combinations. System 200 also may determine the number of exchanges that is required to carry out each of the calculated combinations. Based on these determinations, system 200 selects the combination that generates the greatest aggregate total volume. Where two different combinations results in the same aggregate total volume, system 200 prioritizes and selects the combination that uses a smaller number of trade exchanges. In some embodiments, a combination that uses fewer trade exchanges results in a faster processing time.

Some combination of orders may include partial orders. The partial orders comprise only a portion of an order's desired amount. The remaining portion of the order either remains unmatched, or system 200 matches the remainder against one or more other orders. In some embodiments, system 200 divides an order into multiple partial orders where doing so increases the aggregate total volume.

However, in other embodiments, there may be a minimum amount for executing a partial order. This minimum amount may be specified by the broker, the participant, the trader, or any other entity. For example, the broker may specify that system 200 may not execute a partial order that is less than $1M. The minimum amount of the partial order also may differ for each different currency. In another embodiment, it is possible to opt out of the partial orders altogether, so that the matches are all or nothing.

In other embodiments, multiple orders may be linked together. For example, if Order A and Order B are linked together, then system 200 may match Order A only if a match can be made for Order B as well. Some additional requirements may be set for the linked orders. For instances, there may be a requirement that the linked orders be executed within a certain number of days, so that Order A and Order B must be executed within 30 days of each other. Still in other embodiments, there may be a request to link two orders of different currencies, so that Order A is directed at the Japanese yen, and Order B is directed at the Russian ruble.

Other embodiments of system 200 utilize a matching chain algorithm to increase the aggregate total volume. In a matching chain, system 200 may connect multiple participants together, so that such a combination generates a greater aggregate total volume. FIG. 5 illustrates an example of a matching chain.

As shown in FIG. 5, system 200 determines that a first combination results in an aggregate total volume of 6M. However, system 200 also determines that a second combination generates a greater aggregate total volume. Utilizing a matching chain algorithm, this second combination generates an aggregate total volume of 16M. Specifically, the second combination, as illustrated in FIG. 5, consists of matching several partial orders.

FIG. 5 shows order 514 as having a desired quantity of +10M. However, system 200 has determined that dividing order 514 into a partial order will result in the greatest aggregate total volume. System 200 also has determined that the particular combination illustrated in FIG. 5 produces the greatest aggregate total volume. This particular combination consists of matching buy order 514 with a portion of sell order 518. Sell order 518 corresponds to switch order 520, which is matched against a portion of sell order 522. Sell order 522 corresponds to switch order 524, which is matched against a portion of sell order 526. Sell order 526 corresponds to switch order 528, which is matched against switch order 516 (which corresponds to order 514).

During the matching process, system 200 is limited by several factors when attempting to make a match. System 200 may consider the limitations imposed by the restricted time period and the credit limits associated with each order. Both of these parameters are discussed in greater detail below. System 200 also may consider the zero-sum requirement when attempting to make a match.

For example, as shown in FIG. 5, order 514 is a buy order in the amount of 10M and switch order 516 is a sell order in the amount of −7M. Both order 514 and switch order 516 have a restricted time period of 60-days. Because system 200 requires that all matches satisfy a zero-sum balance, system 200 is able to match only a portion of order 514, namely +7M of the desired +10M amount. The reason for the partial match is because the corresponding switch order 516 has a desired amount of −7M. System 200 cannot make a match for order 514 beyond the +7M amount of switch order 516, because going beyond that amount will cause an imbalance to the zero-sum requirement. On the other hand, system 200 is permitted to make a match for any amount that is equal or less than the desired amount of switch order 516. Thus, the maximum amount that system 200 can match for order 514 is +7M. The remaining +3M of order 514 is unmatched, because there is no switch order amount that is available to satisfy the zero-sum requirement.

Furthermore, because sell order 526 is in the amount of −4M, system 200 can only match a maximum of +4M for corresponding switch order 528. This amount of +4M for order 528 is matched against an amount of −4M for order 516. Since order 528 has a total desired amount of +5M, there is a +1M remainder that is unmatched. Again, system 200 cannot make any additional matches for the +1M remainder of order 528 because doing so will cause an imbalance to the zero-sum requirement.

System 200 also matches the amount of −4M for order 526 with an amount of +4M for order 524. Order 524 is a switch of order 522, and as a result, the limitations imposed on order 524 carries over to order 522 as well. Thus, system 200 may match only an amount of −4M for order 522. Similarly, system 200 matches the −4M amount of order 522 with an amount of +4M for order 520. Since order 520 is a switch of order 518, both orders 520 and 518 are limited to a match of +4M and −4M, respectively.

System 200 matches order 518 with order 514. As described above, order 514 has a desired amount of +10M. However, due to the zero-sum requirement, order 514 can match to a maximum of +7M. Of this +7M amount, only an amount of +4M is matched for order 514, due to the limitations imposed by the other orders within its matching chain. Since only a +4M amount of order 514 is matched, order 514 has a remaining amount of +3M that may be matched elsewhere by system 200 (not pictured). Furthermore, order 514 has an additional remaining amount of +3M that is not matched by system 200, because there is no corresponding switch order amount to satisfy the zero-sum requirement.

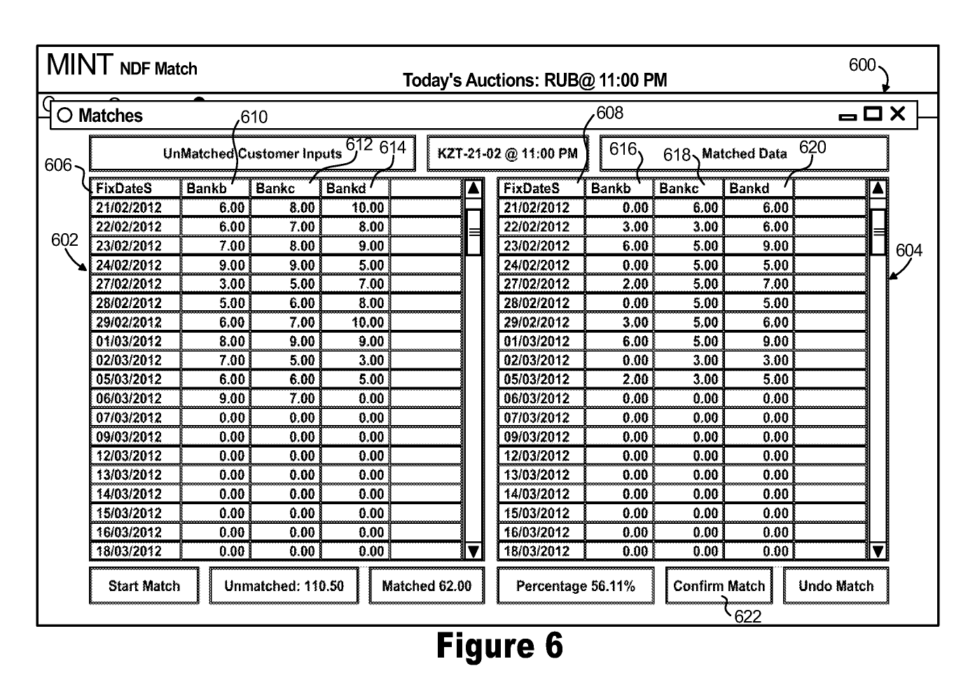

In some embodiments, system 200 receives orders each time that a trader selects submit button 458 in order entry window 400 (see FIG. 4). The submitted orders are then stored into system 200. A broker using broker interface 322 is able to view the submitted orders in matcher window 600 (see FIG. 6). Matcher window 600 is divided into two main sections. Section 602 shows the unmatched customer inputs. These are orders that are still awaiting a match by system 200. Section 604 shows the matched data. These are orders that have been matched, but not yet confirmed by the broker. The broker confirms the matched orders of section 604 by selecting confirmation button 622.

Both sections 602 and 604 include a plurality of rows and columns. Column 606 and 608 lists the available fixing dates for each section. Columns 610-620 represent various traders on system 200. Each row in columns 610-614 shows the desired quantity of an order for a particular fixing date. Each row in column 616-620 shows the matched quantity for a particular fixing date. The matched quantities displayed in columns 616-620 are determined by the matching process of system 200, as described in the example of FIG. 5.

As described above, upon receiving the submitted orders, system 200 calculates all of the possibility combinations between the unmatched orders. As a result, the quantity of unmatched orders affects the processing time that is required to run the matching process. A greater number of unmatched orders results in a longer processing time.

In some embodiments, system 200 applies a selective aiming algorithm before running the matching process. The selective aiming algorithm removes certain orders from the set of unmatched orders in order to generate a smaller set of unmatched orders. The selective aiming algorithm helps reduce the overall processing time of the matching process, because a smaller set of unmatched orders requires less time in calculating all the possible combinations of matches.

The selective aiming process removes both static unmatchable orders and dynamic unmatchable orders from the set of unmatched orders. Static unmatchable orders are orders that have no possibility of a match even before system 200 runs the matching process. One example of a static unmatchable order is an order that has no corresponding switch order. As described above, system 200 requires a zero-sum balance for all matched orders. Therefore, it is impossible for an order that does not have a switch order to satisfy the zero-sum requirement. As such, these orders are considered static unmatchable orders and are removed before system 200 runs the matching process.

Another example of a static unmatchable order is an order that does not meet the minimum tradeable amount. The minimum tradeable amount is the smallest quantity that will be considered by system 200 during the matching process. Orders that do not meet the minimum tradeable amount are removed from the matching process. In the example of FIG. 5, the minimum tradeable amount is 4M, as a result, order 536 in the amount of 2M is consider a static unmatchable order. Thus, system 200 will not consider order 536 during the matching process. Although the example of FIG. 5 designates 4M as the minimum tradable amount, any possible numeric value may be assigned as the minimum tradeable amount.

In some embodiments, the minimum amount is determined by the broker. In other embodiments, the minimum tradeable amount is determined by the trader. Some embodiments have a default tradeable amount which may be further customized by either a broker, trader, client, participant, third party entity, etc. . . .

The selective aiming process also may identify any dynamic unmatchable orders, which system 200 removes from the set of unmatched orders. Dynamic unmatchable orders are affected by each cycle of the matching process. Whereas static unmatchable orders have no possibility of a match, a dynamic unmatchable order would have a possible match, but for one or more limitations that are imposed by certain parameters.

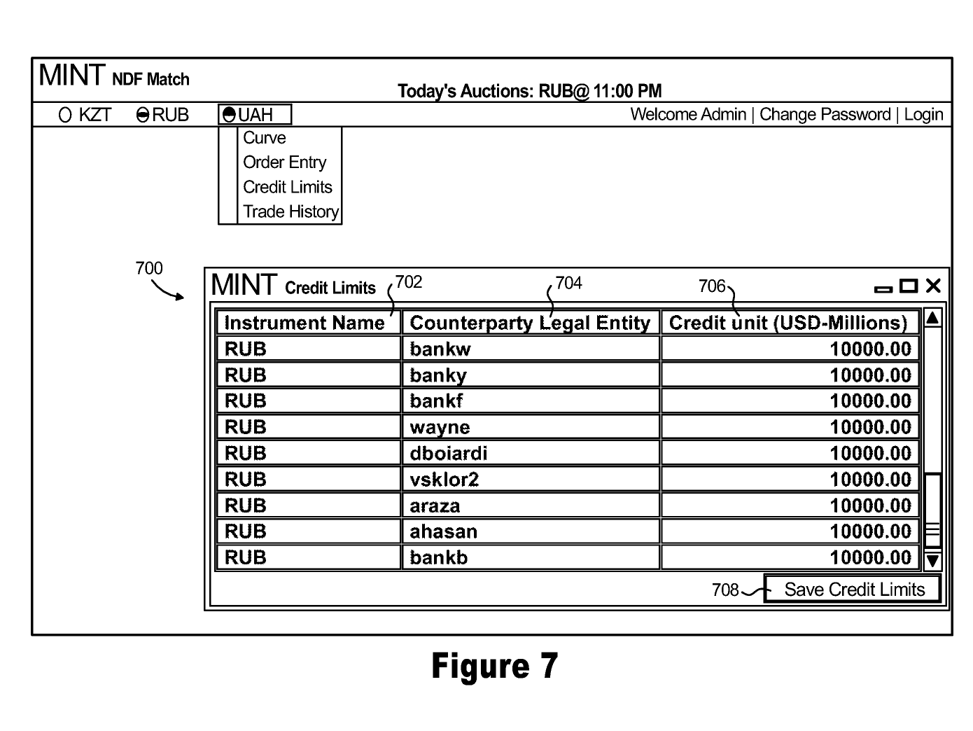

One example of a dynamic unmatchable order is an order that has exceeded a credit limit, or an order whose execution will exceed the credit limit. In one aspect of some embodiments, a participant may wish to limit his exposure on the foreign exchange market. As a result, he may set up limitations on the amount of credit exposure, which is measured as the sum of outstanding loans and loan commitments to the counterparty. This credit exposure limit is the maximum absolute trading amount that can occur between two participants during an entire run interval. Once the two participants have met the maximum amount, then all subsequent trades between the two parties are not matched. As shown in FIG. 7, the credit limit between each participant may be displayed in credit window 700.

The utilization of the limit varies with each subsequent run by system 200. For example, Bank A may be authorized to lend to Bank B, subject to a credit exposure limit of USD 10M worth of foreign currency. System 200 generates a match, in which Bank A agrees to sell USD 8M worth of foreign currency. As a result of this match, the utilization of Bank A's credit limit is USD 8M, which means that Bank A now has a remaining authority to lend up to USD 2M to Bank B. In any future matches, system 200 will not match Bank A with any orders from Bank B that exceeds 2M, since doing so would exceed the remaining credit limit. In fact, any orders whose execution will exceed the credit limit is consider “dynamic unmatchable order.” These dynamics unmatchable orders are removed from the set of unmatched orders during the selective aiming process.

As shown in FIG. 7, credit limit window 700 is generated in response to a user selecting sub-tab 314 of trading interface 300. Credit window 700 includes column 702 which depicts the type of currency and column 704 which depicts the identity of the counterparty. Column 706 shows the credit limits for each of the counterparties of column 704.

In some embodiments, system 200 automatically populates column 706 with default credit limits for each participant. These default credit limits may be established in advance by any number of entities, such as the broker, the trader, the participant, the bank, etc. In some embodiments, the default credit limit is the same for all of the participants.

In other embodiments, the default credit limit varies for each individual participant depending on a number of factors. Some of these factors may include the participant's identity, size, trading history, the desired amount of currency, the type of desired currency, country of origin, etc. For example, participants who trade above certain volume of currency may have a default credit limit that is higher than other participants.

In another example, participants from countries with more established economies may have a higher default credit limit than those from other countries. In at least one embodiment, system 200 assigns a rating to various countries of origin. For example, a country, such as the United States, may receive a high rating because it is a country with a stable economy. By contrast, a country, such as Russia, may receive a lower rating because it is a country with a more volatile economy. Therefore, a U.S. participant may be assigned a higher default credit limit than a Russian participant. System 200 may maintain a plurality of lists, where each country is assigned to a list that is indicative of its economic stability. The assignment may be determined in advanced by the broker, trader, participant, client, third party entity, etc. . . . When system 200 received an order, it may determine the country of origin of the participant and compare that country to the plurality of lists.

In another embodiment, a broker or a trader may submit a list of default credit limits to system 200, so that, for each auction time, system 200 automatically populates column 706 with the default credit limits from this list. In still another embodiment, a trader may wish to place one or more participants on a “black list, i.e., an indication that they do not wish to have any of their orders matched with orders from these participants. As a result, system 200 may automatically reduce the credit limits of these participants to zero.

In other embodiments, the default credit limits may be customized to a different amount. In the example of FIG. 7, a user may double-click a box in column 706 and then type in a new credit limit amount into the box. The user then selects button 708 to save the newly edited credit amount.

Still another example of a dynamic unmatchable order is an order that falls outside the restricted time period of an order. Referring back to FIG. 5, order 514 has a 60-day restricted time period that runs from Day 1 to Day 60. As a result, system 200 will only match order 514 with other orders that fall within the same time period of Day 1 to Day 60. For example, if order 536 has a fixing date on Day 61, then system 200 considers order 536 to be a dynamic unmatchable order, since it falls outside the restricted time period.

After system 200 runs the matching processes, the matched orders appear in section 604 of matcher window 600, as shown in FIG. 6. If the broker is satisfied with the matches, he may select button 818 to confirm these matches. The selection of confirmation button 818 triggers system 200 to execute the matches. In some embodiments, a message is transmitted to each respective trading. In at least one embodiment, the message notifies the trader of a match for one or more of his submitted orders. The message may contain information about the volume quantity for each matched order, the total volume quantity for all of the trader's orders and/or the identity of the counterparties. System 200 also will adjust the available credit limit for each participant based on the cycled matches.

In the examples described in the present application, traders submit a desired quantity of an order. The prices for each order are determined in advance by system 200. These prices are shown via the predicted mid-point rates for each fixing date, as displayed in column 410 of FIG. 4. Thus, if a trader considers the listed mid-point rate to be a fair or attractive price for a particular fixing date, he may decide to place an order on that fixing date. On the other hand, if the trader disagrees with the predicted mid-point rate for a particular fixing date, he may choose not to place his order for that date. In some embodiments, the trader may choose to view the trading curve for the mid-point rates. Referring back to FIG. 3a, the trader may select sub-tab 310 to generate a curve window 800 (as shown in FIG. 8).

Curve window 800 may contain graphical representation 802 of the yield curve and entry box 804. The yield curve includes a vertical axis 806 that depicts the predicted mid-market rates over a period of time. The yield curve also includes a horizontal axis 808 that displays all of the fixing dates within the period of time.

For the non-standardized currencies in emerging markets, there is often no centralized bank for determining the mid-point rates. As a result, different brokers may choose to design their own trading models in order to predict the mid-point exchange rates. Depending on the trading model that is built by a broker, the yield curve by differ from broker to broker.

In some aspects of the embodiments, the trading models are built outside of system 200. The trading model may include a plurality of algorithms, data and predictions by the broker. After the trading models calculate the predicted mid-point rates, the broker imports these mid-point rates into system 200. In other aspects of the embodiments, the trading models are integrated into system 200. System 200 may continuously update the trading models based on recently executed transactions. In at least one embodiment, the updates occur in real-time. In another embodiment, the updates occur during designated periods of time.

Curve window 800 also may include entry box 810 that includes multiple columns. Each column of entry box 810 displays a variety of information, such as the fixing date, the value date, and mid-market rate. Trading interface 300 does not permit a trader to make any changes in entry box 810. He is only permitted to view the curve window 800. However, broker interface 322 permits the user to input and change the data of entry box 510. In one aspect of the embodiments, the broker enters his predicted mid-point values into some of the boxes of entry box 810. For instance, the broker may enter rates for every 7 days, such as Day 1, Day 7, Day 14, and so on. System 200 then interpolates mid-point values in order to generate a mid-point value for each of the fixing dates in the time period. The interpolated mid-points are displayed as yield curve 806.

Referring back to FIG. 4, the trader also may input a desired tolerance in column 416 for a particular order. Tolerance represents a variance (in number of days) for matching the order. For example, a trader may input a tolerance of 1 in column 416 for an order taking place on a fixing date of Mar. 27, 2012. As a result, the system will attempt to match the order on Mar. 27, 2012. However, if the system is unable to find a match on Mar. 27, 2012, then it will look to see if a match may be made one day earlier (March 26) or one day later (March 28).

In another embodiment, the tolerance may be directed at providing more flexibility on when a trader may place the switch order in order to satisfy the zero-sum balance requirement. In another embodiment, there may be a tolerance for the number or amount of trades that do not net out to zero.

After the broker submits the orders for a particular auction, the orders that are processed are stored in a trading history database. A trader may wish to retrieve information from the trading history database in order to review any orders that were previously processed by system 200. Referring back to FIG. 3, the trader may select sub-tab 316 to view the trading history. In response to the selection of sub-tab 316, interface 300 generates trading history window 900. Each of rows 922-942 of trading history window depicts a previously processed order. Column 904 shows the fixing date of the transaction, whereas column 902 shows the type of foreign currency and column 904 shows the mid-point exchange rate that was used. Trading history window 900 also shows the parties involved with each transaction. Columns 910 and 912 depict the seller and buyer, respectively, of the foreign currency. Size column 914 provides information on the quantity of the currency that was matched in the specific transaction.

A broker also may wish to add additional auction times to system 200. From broker interface 322, a broker may select sub-tab 328 which causes system 200 to generate auction window 1000. Auction window 1000 presents the broker with an overview of all active auction times. These are auction times that are still receiving order requests from various traders.

The broker may delete a particular auction by selecting one or more delete buttons 1002-1012. The broker also may choose to send an email. The email may be sent to a client, a trader, a participant, or any other third party entity. In one aspect of the embodiments, the broker selects one or more of buttons 1014-1024 to send an email. A broker may wish to send an email for any number of reasons. For example, the broker may wish to send a reminder email in order to alert customers that the deadline for a specific auction is approaching near. The broker also may wish to send an email to alert customers of a new auction time that has been added.

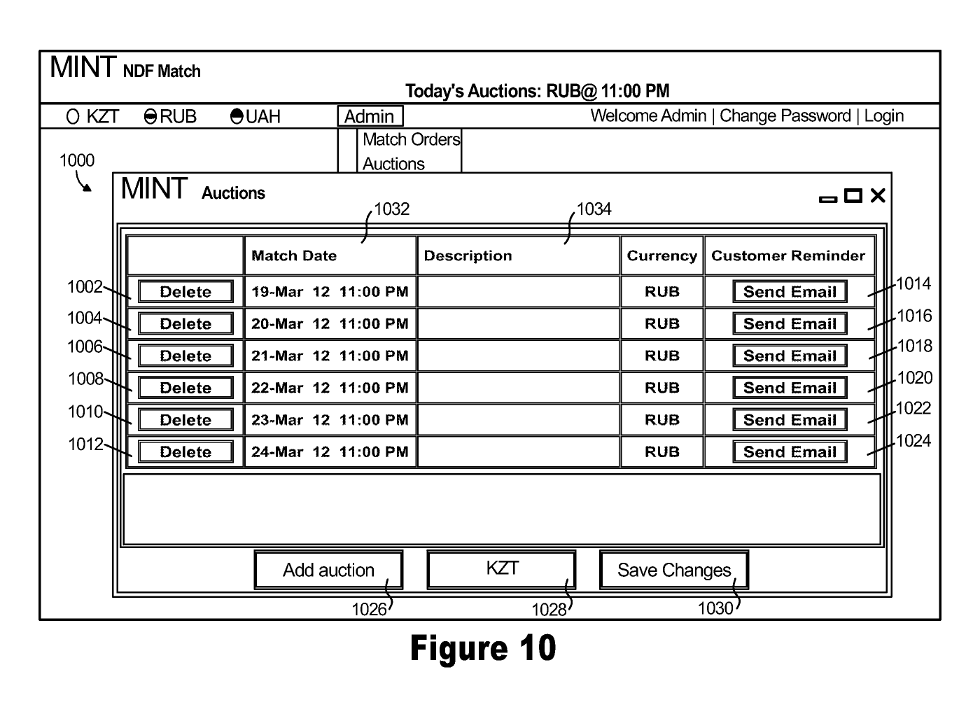

Auction window 1000 also permits the broker to add additional auction times by selecting button 1026. The broker may first select a type of currency using pull-down menu 1028 which contains a listing of all tradeable currencies. After selecting the type of currency, the broker then generates a new row for an auction time via button 1026. In the example illustrated in FIG. 10, the newly generated auction row permits the broker to enter his desired match date, or execution date, in column 1032. The broker also may input a brief description of the newly added auction in column 1034. Once the broker is satisfied with the entry of the newly added auction time, he can save the changes by selecting button 1030. This newly added auction time will be available for access in trading interface 300.

In one aspect of some embodiments, a trader receives a daily risk report from a client. The risk report may include a plurality of requests from the client to buy or sell quantities of various foreign currencies over a period of future dates. In a given day, a trader may receive multiple risk reports from multiple clients. As a result, system 200 must be capable of processing a significantly large number of orders in an accurate and timely manner.

Because a typical risk report may contain multiple buy/sell requests for each day, a trader may wish to avoid manual entry in order to minimize any entry-related errors. Instead, the trader may opt to import the risk report data directly into system 200. To this end, the trader may transport the data from the risk report into a spreadsheet, such as Microsoft Excel. Referring back to order entry window 400 (FIG. 4), the trader may select button 454 which imports that data from the spreadsheet data and automatically populates each field in buy/sell column 412. This process avoids any entry errors that might occur from the trader manually entering orders into column 412. If the trader is satisfied with the numbers that are imported into system 200, he may select button 458 to submit the orders. However, if the trader is not satisfied with either one or more of the numbers that are imported into system 200, he may amend the quantity amount immediately by changing the numbers in column 412. After system 200 has run the orders, the trader may select button 456 to export any data regarding the results of that run into a spreadsheet. The spreadsheet may be provided to the client.

Algorithms

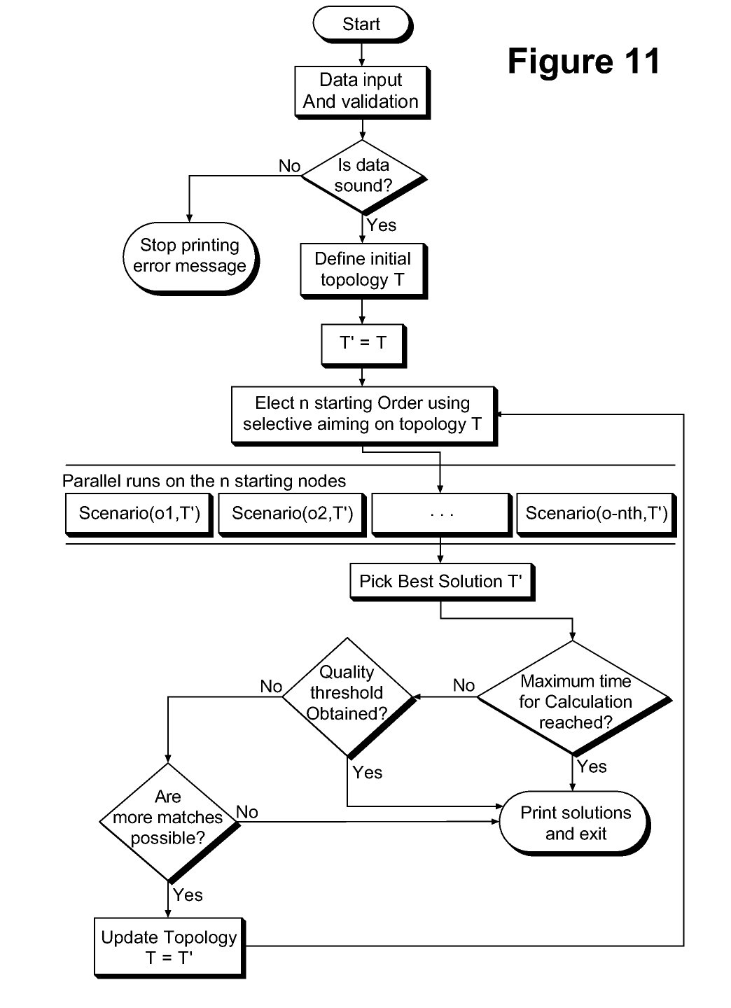

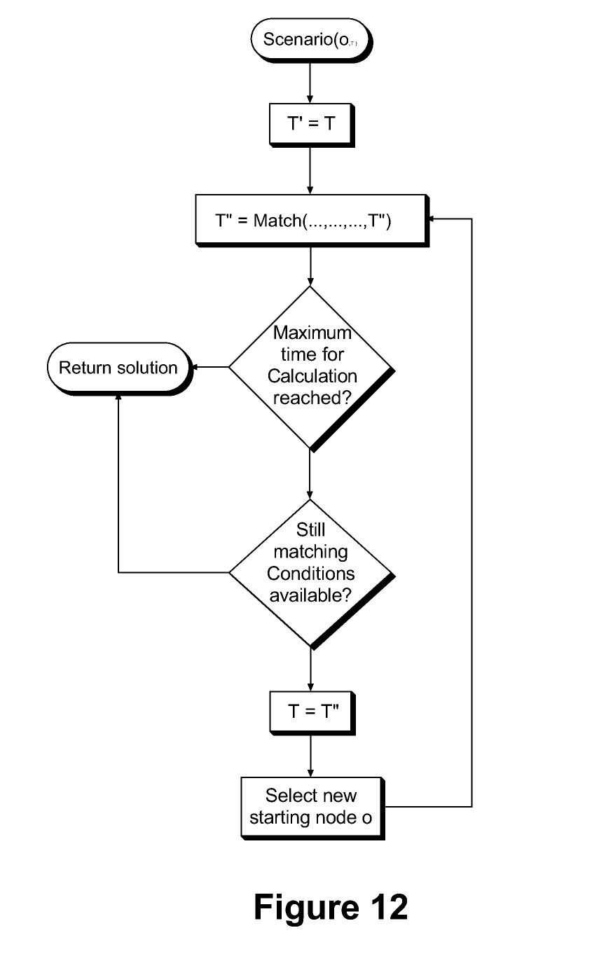

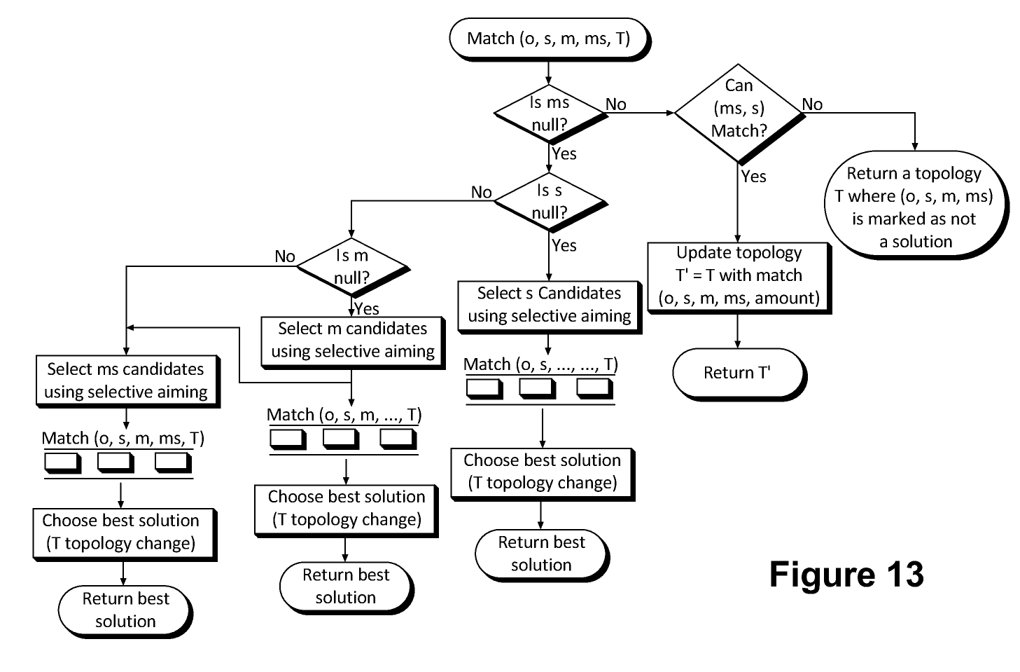

Some additional algorithms associated with system 200. These algorithms are illustrated in the flowcharts depicted by FIGS. 11-13. FIG. 11 is a flowchart illustrating the main body of the matching program. FIG. 12 is a flowchart illustrating the scenario function of the matching program. FIG. 13 is a flowchart illustrating the matching function which occur recursively. The terms client and participants are used interchangeably to refer to an entity that is requesting the quantity of non-standardized currency.

In one aspect of the embodiments, system 200 relies on various parameters and criteria when determining the matches between the orders. Some of these parameters and criteria are described below.

Initially, system 200 defines some parameters, such as the length (in days) of the period available to the match (RUN_DAYS) and the number of clients participating to the match (NUM_CLIENTS). In one embodiment, system 200 defines the following:

D={n|n≧1,n≦RUN_DAYS} is the set of the bookable days for the run.

C={cᵢ|i≧1,i≦NUM_CLIENTS} is the set of the client identifiers.

In this instance, the number of clients and the bookable periods are the two main parameters that define the run. At startup, system 200 may read the daily factors as:

DF={(d,f)|dεD,fε [symbol] }

System 200 also defines the credit lines set between each pair of clients as:

CL={(cᵢ,cⱼ,limit)|cᵢεA,cⱼεA,limitε [symbol] ,limit≧0.0}

As a result, for each client, system 200 defines the set of orders inserted by each client c as:

Oc={(c,amount,date,delta,min)|cεC,amountε [symbol] ,dateεD,deltaε [symbol] N,min_tradeε [symbol] }

O={o|oεO_{c}} thus being O the set of all orders input by all clients.

System 200 also defines the set of reset dates, in which each client inputs an optional sequence of dates that allows him to zero-sum in shorter periods. Each client c defines a set of reset periods as:

RP_{c}={[d1,d2],d1,d2εD| [symbol] [d3,d4]εRP_{c},[d1,d2]∩[d3,d4]=Ø}

For each [d1,d2] closed interval that is specified by each client c, the zero-sum condition is valid for c.

In one embodiment, an order is a tuple (c, date, delta, amount, min_trade) where “c” is the client (or trader) that inputs the order. The “date” is the date of the order. The “delta” is the number of days an order date can be anticipated or delayed to match another order. The “amount” is the signed amount of the order. The “min_trade” is the minimum matchable amount. If an order cannot be even partially matched in the date range [date−delta,date+delta], then the order is not matched. Similarly, if it is possible only to make a partial match with an amount that is less than the min_trade, then the order also is not matched.

An order (c, date, delta, amount, min_trade) is compatible with date “d”, if d is greater than or equal to “date−delta” and d is less than or equal to “date+delta”.

In one embodiment, a possible switch for o(c, date1, delta1, amount1, min_trade1) is an order s(c, date2, delta2, amount2, min_trade2) where “o” and “s” belong to the same client. Both “o” and “s” also belong to the same reset period. The “amount1” and “amount2” are of opposite signs. Furthermore, “amount1” and “amount2” are both greater than “min_trade1” and “min_trade2”, respectively. System 200 defines the following equations:

Sₒ={sεO|s.c=o.c,∃β:s,oεβ,βεB_{c},

sign(o)!=sign(s),

|o.MIN|≦|s.AMOUNT|,

|s.MIN|≦|o.AMOUNT|}

In one embodiment, the matching period is a close interval [start, end] of days in which the submitted orders can be matched, such as booked to a day of the interval. System 200 matches the orders by first determining a trade between order o of client c₁ in the amount a₁ and a match order m of client c₂ with the amount −a₂. The matching order can be assigned to day d, if there is a matched amount: |a|≦|a₁|̂|a|≦|a₂|. Furthermore, client c₁ and client c₂ have a mutual credit line that is greater than: |a|*daily factor.

Both the order and the match order are compatible with date d. There exist a switch order s₁ for order o and a switch s₂ for match m that are matchable (not necessarily together) for the same amount a. The switches belong to the same reset period of the corresponding orders. In addition, the switches themselves are matched with other orders. When a match is found for an amount a in date d between clients c₁, c₂, the credit line (c₁, c₂, limit)εCL has to be decreased. The new credit limit is set to: limit−|a|*DF(d).

In one embodiment, the reset period (also called a “Bubble”) is a zero-sum period that is created by the single trader/client and pertains only to his orders. For example, if the game length is 180 days (interval: [1 . . . 180]), then each client customizes this interval for its own trades. Client c1 defines three intervals: [1 . . . 80] [81 . . . 120] [121 . . . 180]. Client c2 defines two intervals: [1 . . . 60] [121 . . . 180]. Client c3 defines one interval: [1 . . . 120]. As a result, client c3 decides to trade in the [1 . . . 120] period only. The orders from client c1 and client c2 can match in the [1 . . . 60] period. Likewise, the order from client c1 and client c2 can match in the [81 . . . 120] period. The orders from client c1 and client c2 also can match in the [121 . . . 180] period. A deal can see clients c1 and c2 matching in [1 . . . 60], and then see clients c3 and c2 matching in the [1 . . . 60] period. Clients c3 and c1 can close in the [61 . . . 80] period.

In one embodiment, a matching element E is a tuple (o, s, m, ms, amount), where the order “o” and switch order “s” belong to the same bubble, and thus are submitted by the same client. Match “m” and its switch “ms” belong to the same bubble and are of opposite signs. Order “o” and match “m” are of opposite sign and can have date compatibility to be matched together. Switch order “s” and switch of the match “ms” are of opposite sign and can match together as well. System 200 defines the following algorithm in the matching set:

|E.amount|>MIN_TRADE for each MIN_TRADE of o,s,m,ms

E.amount is of the same sign of o amount

A single match is an ordered list of matching elements, where the i-th order “o” is equal to the i-th-1 order “ms”. The i-th switch “s” is equal to the i-th-1 match “m.” The last “ms” is equal to the first “s”. The amount is the same for each tuple. The final matching result “M” of the algorithm is a list of single matches. When printing the matching result “M,” amounts of trades with same c₁,c₂ and day are grouped together.

In one embodiment, a topology “T” is a tuple (orders, matches, credit lines, exclusions), where “orders” contain all the remaining unmatched orders. The “matches” are the matching lists that have been made to transition from the original state. The “credit lines” are the sets of remaining credit lines. The “exclusions” are the sets of orders that are excluded from further matches by the selective aiming criteria.

In one embodiment, the absolute trading amount is defined as the sum of the absolute values of all the trades done in a single run or in a transition from one topology to another. This is the metric used to evaluate the percent of success of the algorithm and to compare different solutions. Basically if M′ and M″ are different outcomes of starting topology M, then M′ is a better solution than M″ if ATA(M′) is greater than ATA(M″).

There may be several types of criteria that are used to reduce the solution space and to choose paths. For example, system 200 may use criteria on orders that comprise reduction and selection criterion. The reduction criteria may drop isolated orders, such as orders with no possible match in delta. The reduction criteria also may drop orders that have been tested in conjunction with all the possible matches. The selection criteria may prefer orders with the biggest matchable amount. Thus, when two orders have the same absolute matchable amount prefer the one with the biggest switch.

System 200 also may use criteria for the reset period. These criteria may include reduction criteria. The reduction criteria may drop isolated bubbles that have no exchanges. The reduction criteria also may drop reset period B if it has only buy or sells. The reduction criteria also may prefer B with less credit lines spreading (trade fairness), where the dependence is on the relationship and not the credit lines.

In one embodiment, system 200 defines the reset period proximity, where the reset period “Bi” of client Ci is near the reset period “Bj” of client Cj, if there are potential matches according to dates and actual credit lines. System 200 also defines the reset period centrality. Given the two reset periods “Bi” and “Bj”, “Bi” is considered more central than “Bj” if the matching orders of “Bi” have potentially more matches in more bubble than the matching orders for Bj. For example, under current credit lines and available matches, Bi can match with more bubbles than Bj.

In one embodiment, system 200 also defines switch criteria for choosing a switch. The switch criteria prefer a switch when it is a switch for fewer orders. Otherwise, switch criteria prefer a switch with an absolute amount that is equal to the absolute amount of the order. If this is not available, then switch criteria prefers a switch with an absolute amount that is greater than the order.

System 200 also may define match selection criteria for choosing a match. Match selection criteria may search an immediate closable match, such as a match that has a switch that closes with the first switch, preferring less central bubbles. Otherwise, the match selection criterion prefers a match in a more central bubble.

To further reduce recursion calls and tree solution complexity, a maximum number of solutions can be set when selecting orders, matches and switches.

### Other Embodiments

A. A method comprising: receiving, from a remote device, an order for a quantity of a non-standardized currency at a predicted exchange rate, wherein the order is to be transacted on a fixing date that occurs within a restricted period of time; storing, via the processor, the order in a database with a plurality of orders that are unmatched, wherein the order and the plurality of orders are received before an auction deadline has expired, wherein the processor and the remote device are in electronic communication over a network; computing, via the processor, that the auction deadline has expired; generating, via the processor in response to the computing that the auction deadline has expired, a set of orders comprising all orders for the non-standardized currency that are unmatched; applying, via the processor, a selective aiming algorithm to the set of orders in order to generate a smaller set of orders; computing, via the processor, all possible combinations of the orders, wherein each combination comprises at least one matching relationship between an order of the smaller set with another order of the smaller set; computing, via the processor, a volume of transactions that is generated by each combination; selecting, via the processor based on the volume of transactions, a selected combination that generates a greatest volume of transactions; and displaying on a display an indication that the selected combination has been selected.

A.1. The method of claim A, wherein a plurality of orders of the selected combination are executed together.

A.2. The method of claim A, wherein a sum of the orders in the selected combination results in a zero-sum balance.

A.3. The method of claim A further comprising: receiving a switch order for the non-standardized currency, wherein a sum of the switch order and the order for the quantity of the non-standardized currency results in a zero-sum balance.

A.4. The method of claim A.3, wherein the switch order has a fixing date that occurs within the restricted period of time.

A.5. The method of claim A, wherein the order is a buy order or a sell order.

A.6. The method of claim A, wherein the restricted period of time is a default period of time that is computed in advance of receiving the order for the quantity of the non-standardized currency.

A.7. The method of claim A.6, wherein the restricted period of time is customizable into a portion of the default period of time.

A.8. The method of claim A, wherein the restricted period of time is customizable into a plurality of periods of time.

A.9. The method of claim A further comprising: computing that the volume of transaction generated by a first combination equals the volume of transaction generated by a second combination; computing that the first combination comprises more matching relationships than the second combination; and selecting the second combination over the first combination.

A.10. The method of claim A further comprising: receiving an indication that the selected combination has been confirmed.

A.11. The method of claim A further comprising: in response to receiving the indication that the selected combination has been confirmed, executing each of the matching relationships of the selected combination.

A.12. The method of claim A further comprising: receiving a request to undo the selected combination; and canceling the selected combination in response to the request to undo.

A.13. The method of claim A further comprising: displaying a percentage of the orders in the smaller set that have been matched, but not yet confirmed.

A.14. The method of claim A, wherein the fixing date occurs at a future time.

A.15. The method of claim A, wherein the quantity of the non-standardized currency is delivered on a value date, wherein the value date occurs after the fixing date.

A.16. The method of claim A, wherein the predict exchange rate is computed by a trading curve, wherein the trading curve is generated by a broker in advance of receiving the order for the quantity of the non-standardized currency.

A.17. The method of claim A.16, wherein the trading curve comprises an interpolation of a plurality of predicted exchange rates for the non-standardized currency.

A.18. The method of claim A.16, wherein the trading curve is generated by at least one trading model.

A.19. The method of claim A.18, wherein the at least one trading model is built by a broker.

A.20. The method of claim A.18, wherein the trading curve generated by the at least one trading model differs from a trading curve that is generated by a different trading model.

A.21. The method of claim A.16 further comprising: receiving a request to view the trading curve; and generating, in response to the request, a graphical depiction of the trading curve.

A.22. The method of claim A, wherein applying the selective aiming algorithm further comprises: removing at least one static unmatchable order from the set of orders.

A.23. The method of claim A.22, wherein the at least one static unmatchable order has no possible matches.

A.24. The method of claim A.22, wherein the at least one static unmatchable order comprises any order that has no corresponding switch order.

A.25. The method of claim A.22, wherein the at least one static unmatchable order requests a quantity of the non-standardized currency that is below a minimum requirement.

A.26. The method of claim A.25, wherein the minimum requirement is computed in advance of receiving the order for the quantity of the non-standardized currency.

A.27. The method of claim 26, wherein the minimum requirement is computed by at least one of: a broker, a trader, a participant, a client and a third-party entity.

A.28. The method of claim A, wherein applying the selective aiming algorithm further comprises: removing at least one dynamic unmatchable order from the set of orders.

A.29. The method of claim A.28, wherein the at least one dynamic unmatchable order comprises a corresponding fixing date that falls outside the restricted period of time.

A.30. The method of claim A.28, wherein the at least one dynamic unmatchable order comprises a quantity that exceeds a credit limit.

A.31. The method of claim A.28, wherein executing the at least one dynamic unmatchable order will exceed a credit limit.

A.32. The method of claim A, wherein the order for the quantity of the non-standardized currency is submitted by a participant; and the method further comprising: receiving at least one credit limit between the participant and another participant, wherein a matching order that exceeds the at least one credit limit is not matched with the order.

A.33. The method of claim A.32 further comprising: receiving a request to view the at least one credit limit; and generating, in response to the request, an interface depicting a plurality of credit limits between a plurality of participants, wherein the plurality of credit limits comprises the at least one credit limit.

A.34. The method of claim A.33, wherein each of the plurality of credit limits is adjustable.

A.35. The method of claim A.33 further comprising: automatically assigning a default credit limit to each of the plurality of participants.

A.36. The method of claim A.35, wherein an amount of the default credit limit that is assigned to each of the plurality of participants depends on an identity of each participant.

A.37. The method of claim A.35, wherein an amount of the default credit limit that is assigned to each participant depends on a country of origin for each participant.

A.38. The method of claim A.35 further comprising: computing that a first participant is from a first country of origin and that a second participant is from a second country of origin; computing that the first country has a strong economic stability; computing that the second country has a weak economic stability; and assigning the first participant a higher default credit limit than the second participant.

A.39. The method of claim A.35, wherein an amount of the default credit limit that is assigned to each participant depends on a volume of transactions that have been executed by each participant.

A.40. The method of claim A.35, wherein an amount of the default credit limit that is assigned to each participant depends on a trading history of each participant.

A.41. The method of claim A further comprising: receiving a request to view a trading history for the participant; and generating, in response to the request, an interface that depicts at least one order that was previously executed.

A.42. The method of claim A, wherein the at least one matching relationship comprises: matching a portion of the order of the smaller set with the another order of the smaller set.

A.43. The method of claim A.42 further comprising: computing a remainder that results from matching the portion of the order of the smaller set; and matching the remainder with a different order of the smaller set.

A.44. The method of claim A further comprising: receiving a request to cancel the order for the quantity of the non-standardized currency.

A.45. The method of claim A.44 further comprising: computing that the request to cancel was received before the auction deadline has expired; canceling the order for the quantity of the non-standardized currency; and transmitting an indication that order has been cancelled.

A.46. The method of claim A.44 further comprising: computing that the request to cancel was received after the auction deadline has expired; and transmitting an indication that order cannot be cancelled.

A.47. The method of claim A further comprising: receiving, after the auction deadline has expired, a plurality of orders for the quantity of the non-standardized currency, wherein the plurality of orders are submitted together.

A.48. The method of claim A.47, wherein the plurality of orders are submitted automatically upon expiration of the auction deadline.

A.49. The method of claim A.47, wherein the plurality of orders are submitted in response to a selection of a submit button.

A.50. The method of claim A.47, wherein the plurality of orders are submitted in response to a detection of a triggering event.

A.51. The method of claim A further comprising: receiving a request to add an additional auction time.

A.52. The method of claim A.51 further comprising: transmitting an indication of the additional auction time.

B. An apparatus comprising: a processor; and a memory, wherein the memory stores instructions which, when executed by the processor, direct the processor to: receive an order for a quantity of a non-standardized currency at a predicted exchange rate, wherein the order is to be transacted on a fixing date that occurs within a restricted period of time; store the order in a database with a plurality of orders that are unmatched, wherein the order and the plurality of orders are received before an auction deadline has expired; compute that the auction deadline has expired; generate, in response to computing that the auction deadline has expired, a set of orders comprising all orders for the non-standardized currency that are unmatched; apply a selective aiming algorithm to the set of orders in order to generate a smaller set of orders; compute all possible combinations of the orders, wherein each combination comprises at least one matching relationship between an order of the smaller set with another order of the smaller set; compute a volume of transactions that is generated by each combination; select, based on the volume of transactions, a selected combination that generates a greatest volume of transactions; and display on a display the selected combination.

B.1. The apparatus of claim B, wherein a plurality of orders of the selected combination are executed together.

B.2. The apparatus of claim B, wherein a sum of the orders in the selected combination results in a zero-sum balance.

B.3. The apparatus of claim B, wherein the memory further stores instructions which, when executed by the processor, direct the processor to: receive a switch order for the non-standardized currency, wherein a sum of the switch order and the order for the quantity of the non-standardized currency results in a zero-sum balance.

B.4. The apparatus of claim B.3, wherein the switch order has a fixing date that occurs within the restricted period of time.

B.5. The apparatus of claim B, wherein the order is a buy order or a sell order.

B.6. The apparatus of claim B, wherein the restricted period of time is a default period of time that is computed in advance of receiving the order for the quantity of the non-standardized currency.

B.7. The apparatus of claim B.6, wherein the restricted period of time is customizable into a portion of the default period of time.

B.8. The apparatus of claim B, wherein the restricted period of time is customizable into a plurality of periods of time.

B.9. The apparatus of claim B, wherein the memory further stores instructions which, when executed by the processor, direct the processor to: compute that the volume of transaction generated by a first combination equals the volume of transaction generated by a second combination; compute that the first combination comprises more matching relationships than the second combination; and select the second combination over the first combination.

B.10. The apparatus of claim B, wherein the memory further stores instructions which, when executed by the processor, direct the processor to: receive an indication that the selected combination has been confirmed.

B.11. The apparatus of claim B, wherein the memory further stores instructions which, when executed by the processor, direct the processor to: in response to receiving the indication that the selected combination has been confirmed, execute each of the matching relationships of the selected combination.

B.12. The apparatus of claim B, wherein the memory further stores instructions which, when executed by the processor, direct the processor to: receive a request to undo the selected combination; and canceling the selected combination in response to the request to undo.

B.13. The apparatus of claim B, wherein the memory further stores instructions which, when executed by the processor, direct the processor to: display a percentage of the orders in the smaller set that have been matched, but not yet confirmed.

B.14. The apparatus of claim B, wherein the fixing date occurs at a future time.

B.15. The apparatus of claim B, wherein the quantity of the non-standardized currency is delivered on a value date, wherein the value date occurs after the fixing date.

B.16. The apparatus of claim B, wherein the predict exchange rate is computed by a trading curve, wherein the trading curve is generated by a broker in advance of receiving the order for the quantity of the non-standardized currency.

B.17. The apparatus of claim B.16, wherein the trading curve comprises an interpolation of a plurality of predicted exchange rates for the non-standardized currency.

B.18. The apparatus of claim B.16, wherein the trading curve is generated by at least one trading model.

B.19. The apparatus of claim B.18, wherein the trading model is built by a broker.

B.20. The apparatus of claim B.18, wherein the trading curve that is generated by the at least one trading model differs from a trading curve that is generated by a different trading model.

B.21. The apparatus of claim B.16, wherein the memory further stores instructions which, when executed by the processor, direct the processor to: receive a request to view the trading curve; and generating, in response to the request, a graphical depiction of the trading curve.

B.22. The apparatus of claim B, wherein an application of the selective aiming algorithm further comprises: removing at least one static unmatchable order from the set of orders.

B.23. The apparatus of claim B.22, wherein the at least one static unmatchable order has no possible matches.

B.24. The apparatus of claim B.22, wherein the at least one static unmatchable order comprises any order that has no corresponding switch order.

B.25. The apparatus of claim B.22, wherein the at least one static unmatchable order requests a quantity of the non-standardized currency that is below a minimum requirement.

B.26. The apparatus of claim B.25, wherein the minimum requirement is computed in advance of receiving the order for the quantity of the non-standardized currency.

B.27. The apparatus of claim B.25, wherein the minimum requirement is computed by at least one of: a broker, a trader, a participant, a client and a third-party entity.

B.28. The apparatus of claim B, wherein an application of the selective aiming algorithm further comprises: removing at least one dynamic unmatchable order from the set of orders.

B.29. The apparatus of claim B.28, wherein the at least one dynamic unmatchable order comprises a fixing date that falls outside the restricted period of time.

B.30. The apparatus of claim B.28, wherein the at least one dynamic unmatchable order comprises a quantity that exceeds a credit limit.

B.31. The apparatus of claim B.28, wherein executing the at least one dynamic unmatchable order will exceed a credit limit.

B.32. The apparatus of claim B, wherein the order for the quantity of the non-standardized currency is submitted by a participant; and the method further comprising: receiving at least one credit limit between the participant and another participant, wherein a matching order that exceeds the at least one credit limit is not matched with the order.

B.33. The apparatus of claim B, wherein the memory further stores instructions which, when executed by the processor, direct the processor to: receive a request to view the at least one credit limit; and generate, in response to the request, an interface depicting a plurality of credit limits between a plurality of participants, wherein the plurality of credit limits comprises the at least one credit limit.

B.34. The apparatus of claim B.33, wherein each of the plurality of credit limits is adjustable.

B.35. The apparatus of claim B.33, wherein the memory further stores instructions which, when executed by the processor, direct the processor to: automatically assign a default credit limit to each participant.

B.36. The apparatus of claim B.33, wherein an amount of the default credit limit that is assigned to each participant depending on an identity of each participant.

B.37. The apparatus of claim B.33, wherein an amount of the default credit limit that is assigned to each participant depends on a country of origin for each participant.

B.38. The apparatus of claim B.33, wherein the memory further stores instructions which, when executed by the processor, direct the processor to: compute that a first participant is from a first country of origin and that a second participant is from a second country of origin; compute that the first country has a strong economic stability; compute that the second country has a weak economic stability; and assign the first participant a higher default credit limit than the second participant.

B.39. The apparatus of claim B.38, wherein an amount of the default credit limit that is assigned to each participant depends on a volume of transactions that have been executed by each participant.

B.40. The apparatus of claim B.38, wherein an amount of the default credit limit that is assigned to each participant depends on a trading history of each participant.

B.41. The apparatus of claim B, wherein the memory further stores instructions which, when executed by the processor, direct the processor to: receive a request to view a trading history for the participant; and generate, in response to the request, an interface that depicts at least one order that was previously executed.

B.42. The apparatus of claim B, wherein the at least one matching relationship comprises: matching a portion of the order of the smaller set with the another order of the smaller set.

B.43. The apparatus of claim B.42, wherein the memory further stores instructions which, when executed by the processor, direct the processor to: compute a remainder that results from matching the portion of the order of the smaller set; and match the remainder with a different order of the smaller set.

B.44. The apparatus of claim B, wherein the memory further stores instructions which, when executed by the processor, direct the processor to: receive a request to cancel the order for the quantity of the non-standardized currency.

B.45. The apparatus of claim B.44, wherein the memory further stores instructions which, when executed by the processor, direct the processor to: compute that the request to cancel was received before the auction deadline has expired; cancel the order for the quantity of the non-standardized currency; and transmit an indication that order has been cancelled.

B.46. The apparatus of claim B.44, wherein the memory further stores instructions which, when executed by the processor, direct the processor to: compute that the request to cancel was received after the auction deadline has expired; and transmit an indication that order cannot be cancelled.

B.47. The apparatus of claim B, wherein the memory further stores instructions which, when executed by the processor, direct the processor to: receive, after the auction deadline has expired, a plurality of orders for the quantity of the non-standardized currency, wherein the plurality of orders are submitted together.

B.48. The apparatus of claim B.47, wherein the plurality of orders are submitted automatically upon expiration of the auction deadline.

B.49. The apparatus of claim B.47, wherein the plurality of orders are submitted in response to a selection of a submit button.

B.50. The apparatus of claim B.47, wherein the plurality of orders are submitted in response to a detection of a triggering event.

B.51. The apparatus of claim B, wherein the memory further stores instructions which, when executed by the processor, direct the processor to: receive a request to add an additional auction time.

B.52. The apparatus of claim B.51, wherein the memory further stores instructions which, when executed by the processor, direct the processor to: transmit an indication of the additional auction time.

C. An article of manufacture comprising: a non-transitory, computer-readable medium that stores instructions which, when executed by a processor, direct the processor to: receive an order for a quantity of a non-standardized currency at a predicted exchange rate, wherein the order is to be transacted on a fixing date that occurs within a restricted period of time; store the order in a database with a plurality of orders that are unmatched, wherein the order and the plurality of orders are received before an auction deadline has expired; compute that the auction deadline has expired; generate, in response to computing that the auction deadline has expired, a set of orders comprising all orders for the non-standardized currency that are unmatched; apply a selective aiming algorithm to the set of orders in order to generate a smaller set of orders; compute all possible combinations of the orders, wherein each combination comprises at least one matching relationship between an order of the smaller set with another order of the smaller set; compute a volume of transactions that is generated by each combination; select, based on the volume of transactions, a selected combination that generates a greatest volume of transactions; and display on a display the selected combination.

C.1. The article of manufacture of claim C, wherein a plurality of orders of the selected combination are executed together.

C.2. The article of manufacture of claim C, wherein a sum of the orders in the selected combination results in a zero-sum balance.

C.3. The article of manufacture of claim C, wherein the non-transitory, computer-readable medium further stores instructions which, when executed by the processor, direct the processor to: receive a switch order for the non-standardized currency, wherein a sum of the switch order and the order for the quantity of the non-standardized currency results in a zero-sum balance.

C.4. The article of manufacture of claim C.3, wherein the switch order has a fixing date that occurs within the restricted period of time.

C.5. The article of manufacture of claim C, wherein the order is a buy order or a sell order.

C.6. The article of manufacture of claim C, wherein the restricted period of time is a default period of time that is computed in advance of receiving the order for the quantity of the non-standardized currency.

C.7. The article of manufacture of claim C.6, wherein the restricted period of time is customizable into a portion of the default period of time.

C.8. The article of manufacture of claim C, wherein the restricted period of time is customizable into a plurality of periods of time.

C.9. The article of manufacture of claim C, wherein the non-transitory, computer-readable medium further stores instructions which, when executed by the processor, direct the processor to: compute that the volume of transaction generated by a first combination equals the volume of transaction generated by a second combination; compute that the first combination comprises more matching relationships than the second combination; and select the second combination over the first combination.

C.10. The article of manufacture of claim C, wherein the non-transitory, computer-readable medium further stores instructions which, when executed by the processor, direct the processor to: receive an indication that the selected combination has been confirmed.

C.11. The article of manufacture of claim C, wherein the non-transitory, computer-readable medium further stores instructions which, when executed by the processor, direct the processor to: in response to receiving the indication that the selected combination has been confirmed, execute each of the matching relationships of the selected combination.

C.12. The article of manufacture of claim C, wherein the non-transitory, computer-readable medium further stores instructions which, when executed by the processor, direct the processor to: receive a request to undo the selected combination; and canceling the selected combination in response to the request to undo.

C.13. The article of manufacture of claim C, wherein the non-transitory, computer-readable medium further stores instructions which, when executed by the processor, direct the processor to: display a percentage of the orders in the smaller set that have been matched, but not yet confirmed.

C.14. The article of manufacture of claim C, wherein the fixing date occurs at a future time.

C.15. The article of manufacture of claim C, wherein the quantity of the non-standardized currency is delivered on a value date, wherein the value date occurs after the fixing date.

C.16. The article of manufacture of claim C, wherein the predict exchange rate is computed by a trading curve, wherein the trading curve is generated by a broker in advance of receiving the order for the quantity of the non-standardized currency.

C.17. The article of manufacture of claim C.16, wherein the trading curve comprises an interpolation of a plurality of predicted exchange rates for the non-standardized currency.

C.18. The article of manufacture of claim C.16, wherein the trading curve is generated by at least one trading model.

C.19. The article of manufacture of claim C.18, wherein the trading model is built by a broker.

C.20. The article of manufacture of claim C.18, wherein the trading curve that is generated by the at least one trading model differs from a trading curve that is generated by a different trading model.

C.21. The article of manufacture of claim C.16, wherein the non-transitory, computer-readable medium further stores instructions which, when executed by the processor, direct the processor to: receive a request to view the trading curve; and generating, in response to the request, a graphical depiction of the trading curve.

C.22. The article of manufacture of claim C, wherein an application of the selective aiming algorithm further comprises: removing at least one static unmatchable order from the set of orders.

C.23. The article of manufacture of claim C.22, wherein the at least one static unmatchable order has no possible matches.

C.24. The article of manufacture of claim C.22, wherein the at least one static unmatchable order comprises any order that has no corresponding switch order.

C.25. The article of manufacture of claim C.22, wherein the at least one static unmatchable order requests a quantity of the non-standardized currency that is below a minimum requirement.

C.26. The article of manufacture of claim C.25, wherein the minimum requirement is computed in advance of receiving the order for the quantity of the non-standardized currency.

C.27. The article of manufacture of claim C.25, wherein the minimum requirement is computed by at least one of: a broker, a trader, a participant, a client and a third-party entity.

C.28. The article of manufacture of claim C, wherein an application of the selective aiming algorithm further comprises: removing at least one dynamic unmatchable order from the set of orders.

C.29. The article of manufacture of claim C.28, wherein the at least one dynamic unmatchable order comprises a fixing date that falls outside the restricted period of time.

C.30. The article of manufacture of claim C.28, wherein the at least one dynamic unmatchable order comprises a quantity that exceeds a credit limit.

C.31. The article of manufacture of claim C.28, wherein non-transitory, computer-readable medium the at least one dynamic unmatchable order will exceed a credit limit.

C.32. The article of manufacture of claim C, wherein the order for the quantity of the non-standardized currency is submitted by a participant; and the method further comprising: receiving at least one credit limit between the participant and another participant, wherein a matching order that exceeds the at least one credit limit is not matched with the order.

C.33. The article of manufacture of claim C, wherein the non-transitory, computer-readable medium further stores instructions which, when executed by the processor, direct the processor to: receive a request to view the at least one credit limit; and generate, in response to the request, an interface depicting a plurality of credit limits between a plurality of participants, wherein the plurality of credit limits comprises the at least one credit limit.

C.34. The article of manufacture of claim C.33, wherein each of the plurality of credit limits is adjustable.

C.35. The article of manufacture of claim C.33, wherein the non-transitory, computer-readable medium further stores instructions which, when executed by the processor, direct the processor to: automatically assign a default credit limit to each participant.

C.36. The article of manufacture of claim C.33, wherein an amount of the default credit limit that is assigned to each participant depending on an identity of each participant.

C.37. The article of manufacture of claim C.33, wherein an amount of the default credit that limit is assigned to each participant depends on a country of origin for each participant.

C.38. The article of manufacture of claim C.33, wherein the non-transitory, computer-readable medium further stores instructions which, when executed by the processor, direct the processor to: compute that a first participant is from a first country of origin and that a second participant is from a second country of origin; compute that the first country has a strong economic stability; compute that the second country has a weak economic stability; and assign the first participant a higher default credit limit than the second participant.

C.39. The article of manufacture of claim C.33, wherein an amount of the default credit limit that is assigned to each participant depends on a volume of transactions that have been executed by each participant.

C.40. The article of manufacture of claim C.33, wherein an amount of the default credit limit that is assigned to each participant depends on a trading history of each participant.

C.41. The article of manufacture of claim C, wherein the non-transitory, computer-readable medium further stores instructions which, when executed by the processor, direct the processor to: receive a request to view a trading history for the participant; and generate, in response to the request, an interface that depicts at least one order that was previously executed.

C.42. The article of manufacture of claim C, wherein the at least one matching relationship comprises: matching a portion of the order of the smaller set with the another order of the smaller set.

C.43. The article of manufacture of claim C.42, wherein the non-transitory, computer-readable medium further stores instructions which, when executed by the processor, direct the processor to: compute a remainder that results from matching the portion of the order of the smaller set; and match the remainder with a different order of the smaller set.

C.44. The article of manufacture of claim C, wherein the non-transitory, computer-readable medium further stores instructions which, when executed by the processor, direct the processor to: receive a request to cancel the order for the quantity of the non-standardized currency.

C.45. The article of manufacture of claim C.44, wherein the non-transitory, computer-readable medium further stores instructions which, when executed by the processor, direct the processor to: compute that the request to cancel was received before the auction deadline has expired; cancel the order for the quantity of the non-standardized currency; and transmit an indication that order has been cancelled.

C.46. The article of manufacture of claim C.44, wherein the non-transitory, computer-readable medium further stores instructions which, when executed by the processor, direct the processor to: compute that the request to cancel was received after the auction deadline has expired; and transmit an indication that order cannot be cancelled.

C.47. The article of manufacture of claim C, wherein the non-transitory, computer-readable medium further stores instructions which, when executed by the processor, direct the processor to: receive, after the auction deadline has expired, a plurality of orders for the quantity of the non-standardized currency, wherein the plurality of orders are submitted together.

C.48. The article of manufacture of claim C.47, wherein the plurality of orders are submitted automatically upon expiration of the auction deadline.

C.49. The article of manufacture of claim C.47, wherein the plurality of orders are submitted in response to a selection of a submit button.

C.50. The article of manufacture of claim C.47, wherein the plurality of orders are submitted in response to a detection of a triggering event.

C.51. The article of manufacture of claim C, wherein the non-transitory, computer-readable medium further stores instructions which, when executed by the processor, direct the processor to: receive a request to add an additional auction time.

C.52. The article of manufacture of claim C.51, wherein the non-transitory, computer-readable medium further stores instructions which, when executed by the processor, direct the processor to: transmit an indication of the additional auction time.

1. A method comprising:
receiving, from a remote device, an order for a quantity of a non-standardized currency at a predicted exchange rate, wherein the order is to be transacted on a fixing date that occurs within a restricted period of time;
storing, via the processor, the order in a database with a plurality of orders that are unmatched, wherein the order and the plurality of orders are received before an auction deadline has expired, wherein the processor and the remote device are in electronic communication over a network;
computing, via the processor, that the auction deadline has expired;
generating, via the processor in response to the computing that the auction deadline has expired, a set of orders comprising all orders for the non-standardized currency that are unmatched;
applying, via the processor, a selective aiming algorithm to the set of orders in order to generate a smaller set of orders;
computing, via the processor, all possible combinations of the orders, wherein each combination comprises at least one matching relationship between an order of the smaller set with another order of the smaller set;
computing, via the processor, a volume of transactions that is generated by each combination;
selecting, via the processor based on the volume of transactions, a selected combination that generates a greatest volume of transactions; and
displaying on a display an indication that the selected combination has been selected.

2. The method of claim 1, wherein a plurality of orders of the selected combination are executed together.

3. The method of claim 1, wherein a sum of the orders in the selected combination results in a zero-sum balance.

4. The method of claim 1 further comprising:
receiving a switch order for the non-standardized currency, wherein a sum of the switch order and the order for the quantity of the non-standardized currency results in a zero-sum balance.

5. The method of claim 4, wherein the switch order has a fixing date that occurs within the restricted period of time.

6. The method of claim 1, wherein the order is a buy order or a sell order.

7. The method of claim 1, wherein the restricted period of time is a default period of time that is computed in advance of receiving the order for the quantity of the non-standardized currency.

8. The method of claim 7, wherein the restricted period of time is customizable into a portion of the default period of time.

9. The method of claim 1, wherein the restricted period of time is customizable into a plurality of periods of time.

10. The method of claim 1 further comprising:
computing that the volume of transaction generated by a first combination equals the volume of transaction generated by a second combination;
computing that the first combination comprises more matching relationships than the second combination; and
selecting the second combination over the first combination.

11. The method of claim 1 further comprising:
receiving an indication that the selected combination has been confirmed.

12. The method of claim 11 further comprising:
in response to receiving the indication that the selected combination has been confirmed, executing each of the matching relationships of the selected combination.

13. The method of claim 1 further comprising:
receiving a request to undo the selected combination; and
canceling the selected combination in response to the request to undo.

14. The method of claim 1 further comprising:
displaying a percentage of the orders in the smaller set that have been matched, but not yet confirmed.

15. The method of claim 1, wherein the fixing date occurs at a future time.

16. The method of claim 1, wherein the quantity of the non-standardized currency is delivered on a value date, wherein the value date occurs after the fixing date.

17. The method of claim 1, wherein the predict exchange rate is computed by a trading curve, wherein the trading curve is generated by a broker in advance of receiving the order for the quantity of the non-standardized currency.

18. The method of claim 17, wherein the trading curve comprises an interpolation of a plurality of predicted exchange rates for the non-standardized currency.

19. The method of claim 17, wherein the trading curve is generated by at least one trading model.

20. (canceled)

21. The method of claim 19, wherein the trading curve generated by the at least one trading model differs from a trading curve that is generated by a different trading model.

22. The method of claim 17 further comprising:
receiving a request to view the trading curve; and
generating, in response to the request, a graphical depiction of the trading curve.

23. The method of claim 1, wherein applying the selective aiming algorithm further comprises:
removing at least one static unmatchable order from the set of orders.

24. The method of claim 23, wherein the at least one static unmatchable order has no possible matches.

25. The method of claim 23, wherein the at least one static unmatchable order comprises any order that has no corresponding switch order.

26. The method of claim 23, wherein the at least one static unmatchable order requests a quantity of the non-standardized currency that is below a minimum requirement.

27-28. (canceled)

29. The method of claim 1, wherein applying the selective aiming algorithm further comprises:
removing at least one dynamic unmatchable order from the set of orders.

30. The method of claim 29, wherein the at least one dynamic unmatchable order comprises a corresponding fixing date that falls outside the restricted period of time.

31. The method of claim 29, wherein the at least one dynamic unmatchable order comprises a quantity that exceeds a credit limit.

32. The method of claim 29, wherein executing the at least one dynamic unmatchable order will exceed a credit limit.

33. The method of claim 1, wherein the order for the quantity of the non-standardized currency is submitted by a participant; and
the method further comprising:
receiving at least one credit limit between the participant and another participant, wherein a matching order that exceeds the at least one credit limit is not matched with the order.

34. The method of claim 33 further comprising:
receiving a request to view the at least one credit limit; and
generating, in response to the request, an interface depicting a plurality of credit limits between a plurality of participants, wherein the plurality of credit limits comprises the at least one credit limit.

35. The method of claim 34, wherein each of the plurality of credit limits is adjustable.

36. The method of claim 34 further comprising:
automatically assigning a default credit limit to each of the plurality of participants.

37. The method of claim 36, wherein an amount of the default credit limit that is assigned to each of the plurality of participants depends on an identity of each participant.

38. The method of claim 36, wherein an amount of the default credit limit that is assigned to each participant depends on a country of origin for each participant.

39. The method of claim 36 further comprising:
computing that a first participant is from a first country of origin and that a second participant is from a second country of origin;
computing that the first country has a strong economic stability;
computing that the second country has a weak economic stability; and
assigning the first participant a higher default credit limit than the second participant.

40. The method of claim 36, wherein an amount of the default credit limit that is assigned to each participant depends on a volume of transactions that have been executed by each participant.

41. The method of claim 36, wherein an amount of the default credit limit that is assigned to each participant depends on a trading history of each participant.

42. (canceled)

43. The method of claim 1, wherein the at least one matching relationship comprises:
matching a portion of the order of the smaller set with the another order of the smaller set.

44. The method of claim 43 further comprising:
computing a remainder that results from matching the portion of the order of the smaller set; and
matching the remainder with a different order of the smaller set.

45. The method of claim 1 further comprising:
receiving a request to cancel the order for the quantity of the non-standardized currency.

46. The method of claim 45 further comprising:
computing that the request to cancel was received before the auction deadline has expired;
canceling the order for the quantity of the non-standardized currency; and
transmitting an indication that order has been cancelled.

47. The method of claim 45 further comprising:
computing that the request to cancel was received after the auction deadline has expired; and transmitting an indication that order cannot be cancelled.

48. The method of claim 1 further comprising:
receiving, after the auction deadline has expired, a plurality of orders for the quantity of the non-standardized currency, wherein the plurality of orders are submitted together.

49. The method of claim 48, wherein the plurality of orders are submitted automatically upon expiration of the auction deadline.

50. (canceled)

51. The method of claim 48, wherein the plurality of orders are submitted in response to a detection of a triggering event.

52. The method of claim 1 further comprising:
receiving a request to add an additional auction time.

53. The method of claim 52 further comprising:
transmitting an indication of the additional auction time.

54. An apparatus comprising:
a processor; and
a memory, wherein the memory stores instructions which, when executed by the processor, direct the processor to:
receive an order for a quantity of a non-standardized currency at a predicted exchange rate, wherein the order is to be transacted on a fixing date that occurs within a restricted period of time;
store the order in a database with a plurality of orders that are unmatched, wherein the order and the plurality of orders are received before an auction deadline has expired;
compute that the auction deadline has expired;
generate, in response to computing that the auction deadline has expired, a set of orders comprising all orders for the non-standardized currency that are unmatched;
apply a selective aiming algorithm to the set of orders in order to generate a smaller set of orders; compute all possible combinations of the orders, wherein each combination comprises at least one matching relationship between an order of the smaller set with another order of the smaller set;
compute a volume of transactions that is generated by each combination;
select, based on the volume of transactions, a selected combination that generates a greatest volume of transactions; and
display on a display the selected combination.

55-106. (canceled)

107. An article of manufacture comprising:
a non-transitory, computer-readable medium that stores instructions which, when executed by a processor, direct the processor to:
receive an order for a quantity of a non-standardized currency at a predicted exchange rate, wherein the order is to be transacted on a fixing date that occurs within a restricted period of time;
store the order in a database with a plurality of orders that are unmatched, wherein the order and the plurality of orders are received before an auction deadline has expired;
compute that the auction deadline has expired;
generate, in response to computing that the auction deadline has expired, a set of orders comprising all orders for the non-standardized currency that are unmatched;
apply a selective aiming algorithm to the set of orders in order to generate a smaller set of orders;
compute all possible combinations of the orders, wherein each combination comprises at least one matching relationship between an order of the smaller set with another order of the smaller set;
compute a volume of transactions that is generated by each combination;
select, based on the volume of transactions, a selected combination that generates a greatest volume of transactions; and display on a display the selected combination.

108-159. (canceled)
